(19) United States
(12) Patent Application Publication
(10) Pub. No.: US 2014/0097083 A1
(43) Pub. Date: Apr. 10, 2014

(54) Transient Stimulated Three Body Association Reactions For Controlling Reaction Rates And Reaction Branches

(71) Applicants: Anthony Zuppero Zuppero, Pollock Pines, CA (US); Thomas J. Dolan, Urbana, IL (US)

(72) Inventors: Anthony Zuppero Zuppero, Pollock Pines, CA (US); Thomas J. Dolan, Urbana, IL (US)

(21) Appl. No.: 13/646,693

(22) Filed: Oct. 6, 2012

(51) Int. Cl. B01J 19/08; C25B 9/00

(52) U.S. Cl. CPC B01J 19/08; C25B 9/00
USPC 204/252; 422/186; 422/119

(57) ABSTRACT

A transient distribution of electron quasiparticles with elevated effective mass is created by adding a targeted range of both crystal momentum and electron energy in a conductor to place electrons into regions of the electronic band structure diagram having a chosen, desired curvature. Effective mass scales as the inverse of curvature. The quasiparticles form transient bonds with delocalized ions and other reactants in or on a reaction particle where reaction rates and branches are controlled by the choice of effective mass.

### FIELD OF THE INVENTION

The invention relates generally to modifying the rates and branches of three-body association reactions, and in particular to modifying the effective mass of the electron quasiparticle forming a transient covalent bond with energetic associating entities.

### BACKGROUND

Nano-surface physical chemistry during the last dozen years revealed an unexpected reaction that released most of the vibrational oscillation energy of a molecule to a single electron bonded to the molecule—in one step. It was unexpected because vibrations cannot lose that much energy in one quantum step. It was immediately useful because the fast moving single electron can be a useful electric current. Molecular internal vibration energy had been efficiently converted into electric current in one quantum step. Nienhauss (1999) and Huarig (2000) started this work. The electron was assumed to have an effective mass of 1 electron.

At first, experimenters supplied the energy to cause the molecular constituents to oscillate with the large amplitude apparently needed to cause the direct electron ejection. Molecules excited by a laser or free radical chemical reactants collided with a conductor surface and energetic electrons were directly ejected. Direct charge ejection only happened on a conductor. Wodtke 2008 explained how these happen, and tells why the Observations seemed to be impossible. They would violate a principle of physics referred to as the Born-Oppenheimer Approximation (BOA), where highly energetic vibrational energy cannot be quenched in one step.

Ji et al, used chemical fuels to supply the vibrational energy, as in FIGS. 1, 1B and FIG. 2. Adsorbed carbon monoxide (CO) 23 and adsorbed Oxygen (O) 22 on a nanometer-thin, conducting catalyst surface 26 generated electricity 24, 25 using VPEE. A Schottky diode 27 formed by the junction of the catalyst conductor with a semiconductor supporting the catalyst converted the fast moving electron energy into a useful voltage 24 of about 0.68 electron volts at a measurable current 25, as shown in FIG. 2. No connection was made to the effective mass of the electron participating in VPEE, nor to using effective mass to control the reaction.

Multiple, repeated experiments using a range of chemical constituents confirmed the enigmatic observations now referred to as “Vibrationally Promoted Electron Emission” (VPEE), according to LaRue 2011.

The three-body nature of the VPEE process converted reaction energy into electricity. The crucial role of the low mass third body can be understood intuitively using a property of a covalent bond modeled simply by the theory of the H₂⁺ ion, where two positives are bonded together by the negative electron between them. FIG. 3 shows that when entities 31 of the type that both attract an electron 32 in a potential well between them and also vibrate and oscillate energetically toward each other, then at the oscillation inner turning point the electron's Heisenberg uncertainty pressure 34 can completely stop the oscillatory motion and reverse its direction. This is generically described by Ashkenazi and Katz in a description for students who did not have more than basic quantum physics.

The positive nuclei, protons, are attracted by the electron between them, repelled by their like charges (a weaker effect because of 1/r^{r} coulomb forces), and repelled by the quantum-mechanical “Heisenberg pressure” of the electron when it is confined to a small region between the positive entities. At the inner turning point, the Heisenberg pressure prevents collapse of the electrons into the protons, and pumps all the vibration energy entirely into the electron.

When the vibration energy is sufficient, the electron can absorb all the energy and be ejected, leaving the entities associated together with relatively little energy. The entities must be able to bond without an electron between them. This occurred in VPEE and also occurred in processes referred to as “Vibrational Autoionization.”

VPEE enabled the reaction to go in this direction or branch. This branch represents a three body association reaction. Two heavy objects begin completely separate and far apart. Their attraction causes them to collide violently together with the full system energy. The low mass electron between them is forced to stay between them by coulomb electric forces if the bodies are electrically relatively positive. If the two bodies can form a stable product without the electron, they can associate together and form a stable product. If the electron can take the excess energy away, the result is a three-body association reaction with the products associated and relatively less energetic. The research did not emphasize this analogy to a three body association reaction. VPEE was not known until recently.

in VPEE, the third body, an electron, comes from a conductor. It is attracted out of the conductor by the electrical forces of the other two bodies. The two bodies promptly pump up the electron energy as the two bodies attempt to merge into one, sending the electron back into the conductor with a substantial fraction of the association reaction energy. The electron effective mass as a control over the reaction itself was not considered.

LaRue et al (2011) observed one VPEE surface reaction outcome where apparently all the available bond energy was transferred from the chemical system to a single electron. No connection was made to use modified electron effective mass to enhance the yield of this most useful branch.

Effective mass can be changed by crystal momentum. An unexplained, and in some cases dramatic acceleration of chemical, hydrocarbon oxidation reaction rates on a thin, Pd or Pt catalyst surface was reported by several different research groups (Inoue et al, Saito et al., Kelling et al., King et al.). Their common process included a piezoelectric Surface Acoustic Wave generator supporting the thin catalyst that incidentally injected crystal momentum into the reaction surfaces.

None of this research taught or proposed that the rate of reaction or the branch of the reaction could be modified by transiently changing the effective mass of the electron quasiparticle abstracted from the conductor.

Concurrently, dozens of research groups reported claims of large total heat energy anomalously generated in conductors hosting reactants. Chemical processes could not supply such large energy. The same experiments invariably displayed stable isotopes not present in the initial materials. Radiation and nuclear reaction products were not observed except as almost immeasurable traces near the detection limit, thereby eliminating known nuclear processes as the main reaction branch. These observations would be dismissed as impossible and flawed experimental technique, except that when taken in their entirety the observations revealed the characteristic signature of VPEE, but with an elevated electron quasiparticle effective mass.

Common elements were observed in all the anomalous observations. A reactant ion apparently always moved through the conductor as if it were delocalized along with the delocalized electrons of the conductor. In each successful anomalous reaction, the mass-energy (E=m c2) of the reactants always exceeded the mass energy of the product of the same reactants if associated together. The energy always appeared as heat, and not in the expected ways where nuclear products and radioactive entities dominate.

The key common element is that each anomalous observation was accompanied by processes that imparts crystal momentum to an electron in the lattice. The term “crystal momentum” is a solid state physics term associated with the band structure diagram of crystals. Adsorption and description result in addition or subtraction of crystal momentum. Electromigration, ion flow in ionic electrolytes, and certain laser excitation act similarly. When hydrogen or deuterium reactant was injected into the materials a crystal momentum was added to the lattice. Crystal momentum injection was always present.

Others reported anomalous heat energy production and stable isotopes after a high peak power electron current pulse was passed through a metal immersed in water or heavy water. In some pulsed electron beam experiments, the only chemical element present is the target, a copper metal element. In other experiments, traces of unexplained highly energetic particles of unknown type are recorded in detectors placed tens of centimeters from the target. Boiling electrolytes were associated with anomalous reaction. A highly energetic, short pulse laser caused nuclear reaction products in materials holding either hydrogen or deuterium. FIGS. 5A, 5B show a table of some of these anomalous categories, and FIGS. 26A and 26B show a sample of observed reactions.

All of the anomalous isotope observations are either predicted by or consistent with three body association reactions with nuclei if the electron were heavier than it is. None of these experimental claims made any known connection to VPEE processes. Nor was any mention made of the common feature of crystal momentum added to electrons.

Many theorists suggested that an electron in a conductor with elevated effective mass could cause the observed reaction rates if the process were nuclear fusion, a two body process. However, the lack of nuclear products excludes two body fusion. Widom et al. showed how an electron quasiparticle in the conductor could acquire the required, elevated effective mass. Their electron appears to have far too much kinetic energy to bond with the reactants. No one considered a process generating a transient elevated effective mass with low kinetic energy.

Several authors calculated the reaction particle atom size as a function of electron effective mass for reactants including those used in anomalous chemistry experiments. An effective mass between about 6 and about 12 was shown to be sufficient to account for observed reaction rates if tunneling caused fusion. Mizuno calculated steady state effective mass values as high as 10 for particles with dimension as small as 10 lattice numbers. However, fusion would produce energetic products, while only tiny traces were observed. Many authors taught that such electrons would engage in a nuclear weak interaction forming neutrons. Neutrons had only been observed as a trace.

No one taught that such a tunneling can initialize the equivalent of VPEE with total vibration energy thermally slightly greater than the reaction energy. No one taught that these high energy reactions have schematics and potential energy diagrams functionally the same as the chemical counterparts.

The literature did not reveal or teach that the potential energy diagram and schematic of the anomalous chemistry processes seemed to be nearly identical to that of VPEE, as in FIGS. 4, 4A, 4B and 4C. When the quantum mechanical potential energy diagram of two processes are the same, the solution classes should be the same.

Missing in the literature was a requirement to add specific ranges of crystal momentum and energy to a conduction electron. This disclosure shows the value of this requirement. The literature did not teach that in all known cases where experiments observed or described anomalous effects, there always existed a process that generated both a substantial pulse of crystal momentum injected directly into a conductor immersed in reactant(s) and in a way that would transiently modify the effective mass of the electron. Godes ignored the need to intimately couple momentum with the electron.

No experiments and none of the theories mention or show how to generate a transient ensemble of elevated effective mass electrons that can be used in any of the desired ways.

It would be highly useful to be able to generate transient populations of elevated mass electron quasi particles having almost no kinetic energy in or on a conducting material where ions are also delocalized in or on the material.

### SUMMARY

Processes and devices are described to control the reaction rate and reaction branch between two reactants of certain three body association reactions. Such reactions include two relatively positive atoms, molecules or nuclei that can form a stable product, and a low mass negative particle, an electron quasiparticle, as the third body. Embodiments dynamically control the effective mass of the electron quasiparticle, which provides the desired control.

One controlled reaction branch starts with reactants and an electron together having a total energy well in excess of a ground state of a product consisting of just the reactants without the electron. When one models raising the effective mass, m*, from a value far below the electron rest mass to far above, one finds that a threshold exists below which no reaction occurs. The two reactants and the electron do not bond. At threshold, all the reaction energy can be taken away from the reaction by a single electron quasiparticle, leaving the associated product with no excess energy. The product is two atoms, molecules or nuclei that associate into one, in the ground state.

Sharply contrasting familiar two-body nuclear or chemical fusion reactions, this controlled branch of the three-body association reaction can result in complete conversion of the available reaction energy into a form of electrical energy in one step, in the form of electron quasiparticle kinetic energy. This effect can be well described by recent discoveries from Physical Chemistry referred to as “Vibrationally Promoted Electron Emission,” (VPEE) and “Vibrational Autoionization,” but only if we raise or lower the electron quasiparticle effective mass.

The problem of controlling the rate and/or branch of such a reaction is solved by raising or lowering the effective mass of the low mass third body, the negative charge.

The problem of raising the electron effective mass in a conductor is solved in part by adding both crystal momentum and energy to an electron thermally close to the Fermi level, which is a semiconductor physics method. Electrons in metals, semiconductors and insulators can often be modeled and used as quasiparticles that respond to forces as if they had an effective mass that is heavier or lighter than a real electron. This formalism is an approximation in a model where the electrons and ion quasiparticles move and act as if they were real particles with modified properties. The model applied to nuclei, referred to as an electro-nuclear reaction, describes the combined effect of (1) protons and electrons accelerated by the electric coulomb force and (2) the same protons with adjacent neutron(s) accelerated by the nuclear strong force.

The electron quasiparticle effective mass at a given energy, E, and momentum, k, is proportional to the reciprocal of the curvature of the band structure diagram at (k,E). The problem of modifying the effective mass of an electron quasiparticle in a conductor or crystal is solved by locating an inflection point on the electron band structure diagram, where the curvature approaches zero, selecting a point near it with the required, pre-calculated curvature, and injecting the corresponding energy E and crystal momentum k into the lattice to place an electron quasiparticle at that point or in a distribution including that point. The resulting electron kinetic energy can be modified in a way where electrons have only thermal kinetic energy.

The problem of coupling the modified effective mass with a reactant is solved by delocalizing the reactant in the same location as the delocalized, thermal electron quasiparticle. The reactant becomes a delocalized ion quasiparticle. Embodiments delocalize the ion by providing the energy needed to permit it to surmount the confining potentials in the crystal, or to tunnel through them, exactly as in semiconductors. These are completely analogous to the electron and hole charge carrier quasiparticles in semiconductors which form the basis for light emitting diodes. FIG. 9 suggests how an electron quasiparticle with thermal kinetic energy can bond with the ion quasiparticle to form an atom quasiparticle.

Embodiments take advantage of the property found in similar, atom-like quasiparticles in semiconductors called excitons. Excitons and atom quasiparticles can respond like a single entity, and can be formed from electron quasiparticles with modified effective mass. Such quasiparticles in conductors and semiconductors act as if they were a real particle and can form transient molecules or liquids, but only during the lifetime of the quasiparticle. The problem of causing a three body electro-nuclear association reaction with modified electron effective mass is solved in part by using atom quasiparticles as reactants. Controlling quasiparticle effective mass is only required for as long as it takes for the reaction to occur, which is typically less than tens of femtoseconds.

The resulting atom quasiparticle can form a transient covalent bond with relatively positive reactants, such as atoms, molecules or nuclei. The problem of providing the proper reaction environment is solved by embedding the reactants in or on a solid state semiconductor or conductor and modifying the effective mass of co-located electron quasiparticles. A conductor can be synthesized transiently from a semiconductor or insulator.

Embodiments limiting particle size can enhance performance. Limits to the largest useful particle size include the mean free paths of the electrons and phonons, and the distance an electron travels during a half period of the highest energy optical phonon. The resulting particle dimension is typically of order 2 to 15 nanometers. The elevated effective mass is a transient with a lifetime directly limited by these mean free paths and distances. The lifetime is of order 1 to 10 femtoseconds.

The problem of injecting crystal momentum can also be solved by bombarding the reaction particles with energetic masses. The problem of controlling the magnitude of the momentum injection is solved in one method by including tailored momentum injection materials having a calculated bombardment momentum close to the optimum. The optimum is given by the E vs k band diagram, as described above. Bombardment energies include, for example, the adsorption or desorption energy, a chemisorption energy or a physisorption energy.

Many methods are known to inject crystal momentum, including electromigration, electrically overdriving a current through the conductor, energizing materials surrounding the reaction particle to adsorb and/or desorb, energizing the region around the reaction particles with electric current or extreme current pulses in a way that energizes tailored momentum injection materials, direct injection of particles using devices such as electrically driven ion guns or electrolytes, exciting optical phonons, electrically causing oscillatory motion in nanomechanical resonators connected to the reaction particle, using Surface Acoustic Wave (SAW) devices, and using nanomechanical oscillators such as single walled nanotubes or C60 placed in contact with the reaction particles and caused to oscillate with applied potential.

A simple method to optimize the lifetime of the transients is to physically disconnect the reaction particles from any other masses, e.g. to arrange for the reaction particles to exist in the transient vacuum existing during a time less than the mean time between gaseous collisions, which is typically about 100 picoseconds. Surrounding the particles with tailored momentum injection materials and energizing the materials to become gaseous without substantially destroying the reaction particles provides such a vacuum around the particles. An approximation to this includes forming and using weakly connected reaction particles, such as sponge-like connections, percolation connections, or nodule-like links to each other.

The problem of injecting energy into the electron quasiparticles is solved using any one of a plethora of known methods, including injecting energetic photons such as are produced in semiconductor light emitting devices, lasers, electric arcs, glow discharges, and injecting hot electrons produced by forward biased diodes and junctions, and by injecting heat.

Other features and associated advantages will become apparent to those of ordinary skill in the art with reference to the following detailed description of example embodiments in connection with the drawings described below.

### BRIEF DESCRIPTION OF THE DRAWINGS

The accompanying drawings, Which are included as part of the present specification, illustrate the presently preferred embodiment and together with the general description given above and the detailed description of the embodiments given below serve to explain and teach the principles of the present teachings.

FIG. 1 schematically shows a three body reaction with an electron as low mass third body and characterizes the constituent arrangement for Vibrationally Promoted Electron Emission (VPEE).

FIG. 1B shows the chemical reaction that produced electricity.

FIG. 2 shows the device using the VPEE chemical reaction to produce electricity.

FIG. 3 shows an H₂⁺ ion tutorial showing electron energized with entire vibration energy once per oscillation.

FIG. 4 shows the schematic similarities of VPEE-type three-body systems.

FIG. 4A shows a potential energy diagram for three body association reaction with relatively low mass electron quasiparticle as third body.

FIG. 4B shows a potential energy diagram for surface chemistry using a three body association reaction.

FIG. 4C shows a potential energy diagram for anomalous chemistry using a three body association reaction.

FIG. 5A shows Some Anomalies Representing Dominant Reactions

FIG. 5B shows Some Anomalies Representing Dominant Reactions

FIG. 6 shows a segment of a typical band structure diagram for electrons in a conductor, highlighting the inflection point and the energy and crystal momentum injection magnitudes.

FIG. 7 illustrates the apparent size of atom quasiparticles as a function of curvature.

FIG. 8 illustrates the relative size of various reaction particle effects.

FIG. 9 shows the evolution of an atom quasiparticle from ion and electron quasiparticles

FIG. 10 shows a potential energy diagram for electro-nuclear association reaction enabled by an elevated effective mass electron quasiparticle associated with a bare ion quasiparticle.

FIG. 11 shows the intersection of the electron Heisenberg uncertainty energy with the ground state of an associated product of a three-body reaction.

FIG. 12 shows stimulated three body association reaction between a delocalized, positive reactant nucleus, an elevated effective mass electron quasiparticle, and a positive reactant nucleus.

FIG. 13 NONE

FIG. 14 shows a method to turn on and turn off a reaction by control of effective mass.

FIG. 15 shows a method to control reaction branch internal energy by control of effective mass.

FIG. 16 shows adsorbed masses on a reaction particle to suggest methods for crystal momentum injection.

FIG. 17 shows desorbtion induced by electronic transition (DIET) incidentally also injecting crystal momentum.

FIG. 18 shows heat and desorbtions injecting crystal momentum.

FIG. 19 shows diffusion and electrolytes used as a crystal momentum injector.

FIG. 20 shows electromigration as a crystal momentum injector.

FIG. 21 shows electrically overdriven phonons as a crystal momentum injector.

FIG. 22 shows a band structure diagram of E vs k for an electron in a conductor, where the entire Brillouin zone is populated with energy and crystal momentum in a haphazard way.

FIG. 23 shows a band structure diagram for Palladium Hydride, from Mizusaki 2003.

FIG. 24 shows a band structure diagram of E vs k for an electron in a conductor, where only a targeted region of the Brillouin zone is populated with energy and crystal momentum.

FIG. 25 NONE

FIG. 26A shows transient stimulated three body association reaction branch products using only a single atom quasiparticle.

FIG. 26B A table of reaction branch examples and observations for a transient, stimulated three body electro-nuclear association reaction using multiple atom quasiparticles.

FIGS. 26-29 NONE

FIG. 30 shows reaction particle participants.

FIG. 31 shows pump system elements.

FIG. 32 shows an electric generator using transient, stimulated three body association reactions and a thermionic converter.

FIG. 33 shows a stimulated three body reaction device using a pn junction energy converter.

FIG. 34 show an Iwamura reaction device using proton electrolyte reactant injection.

FIG. 35 shows an device designed to be efficient by including targeted energy and crystal momentum injection pumps.

FIG. 36 shows phase locked energy and crystal momentum injection

FIG. 37 shows a solid state energy converter device.

FIG. 38 shows a thermionic energy converter device.

FIG. 39 shows an energized mass working fluid device.

FIG. 40 shows a three body modified electron effective mass association/disociation reaction engine

### DETAILED DESCRIPTION

The disclosure and the various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

To describe the embodiments that control the rate and branch of transient, stimulated three-body association reactions where the third body is an electron quasiparticle with modified effective mass it is best to briefly describe the physical phenomena whose application is part of the embodiment.

This disclosure shows how to control the branch and rate of stimulated three-body association reactions by dynamically controlling and modifying the effective mass of the low mass third body, an electron quasiparticle. The first two bodies are reactants.

During the last dozen years, researchers discovered and began to understand an enigmatic set of observations of physical chemistry now referred to as “Vibrationally Promoted Electron Emission.”

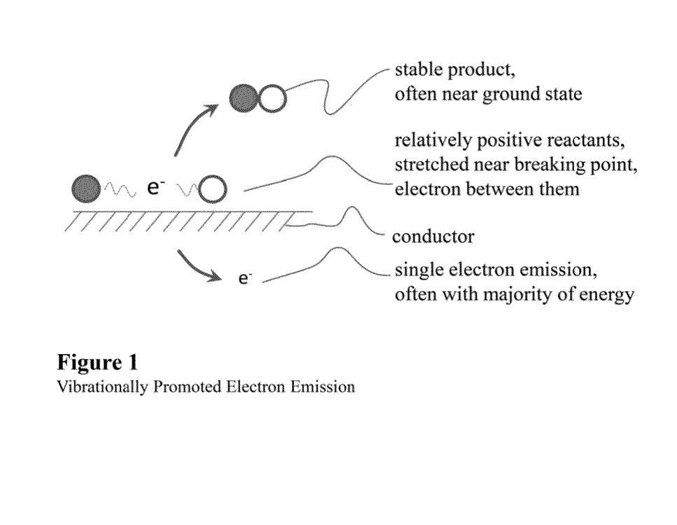

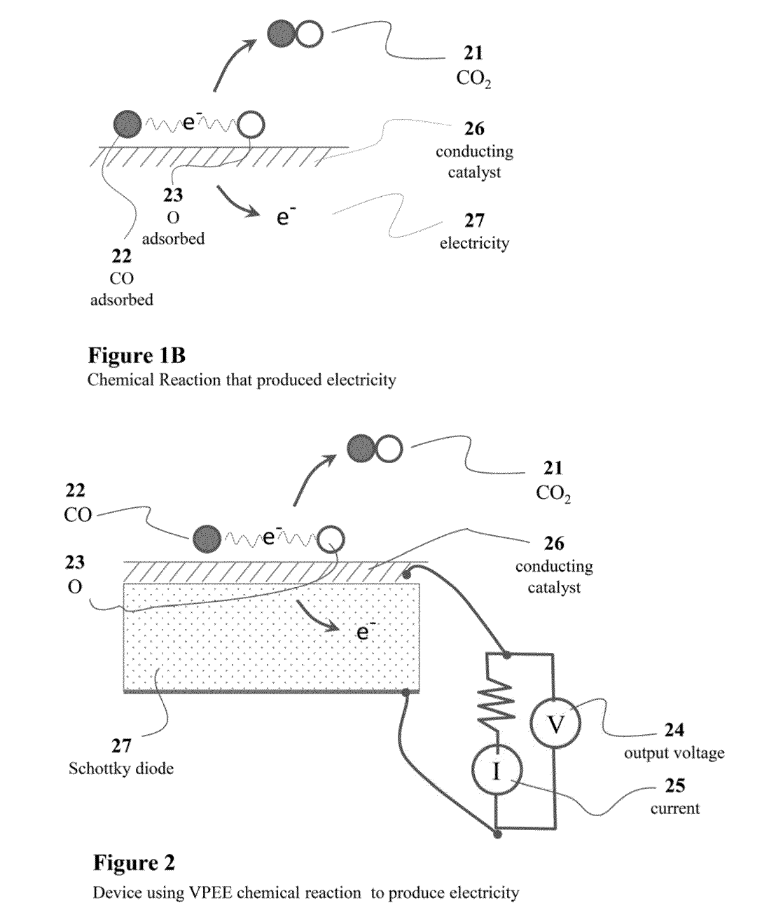

As shown schematically in FIGS. 1 and 1B, two massive reactants 22 and 23 that can exist as a stable product 21 begin as reactants in or on a conductor 26. In experiments, adsorbed carbon monoxide 22 and adsorbed oxygen 23 on a palladium catalyst conductor 26 share an electron they attract from the conductor. When the two reactants join to form a carbon dioxide product 21, an electron is emitted 27 that takes a useful fraction of the energy with it.

Electricity was generated as shown in FIG. 2 by bonding the palladium conductor to a semiconductor. The conductor 26 and semiconductor form a Schottky diode 27. The electron charges the diode in the same way an electron energized by light charges a photovoltaic diode. Electron kinetic energy is converted into a potential between the semiconductor and the conductor. A useful voltage 24 and current 25 were observed.

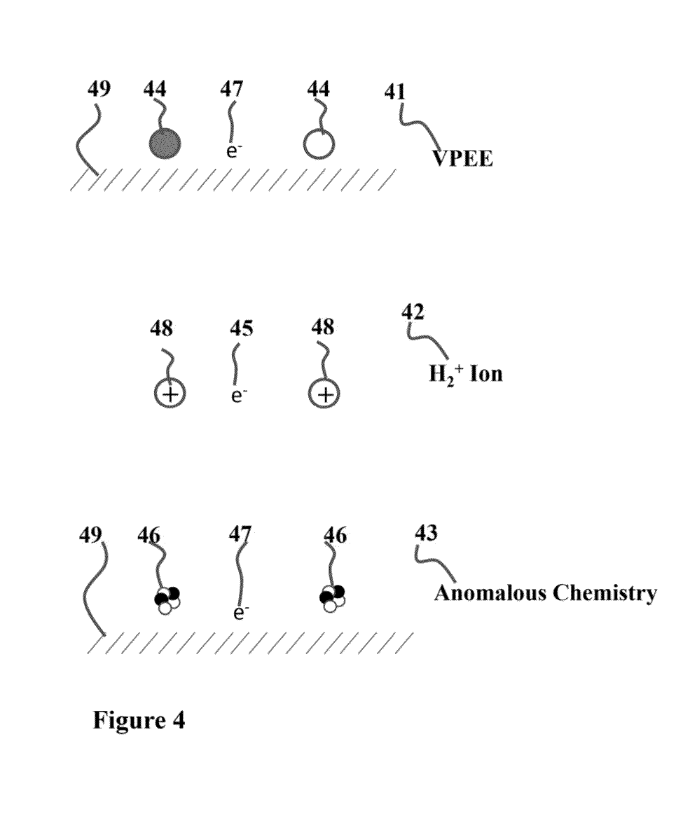

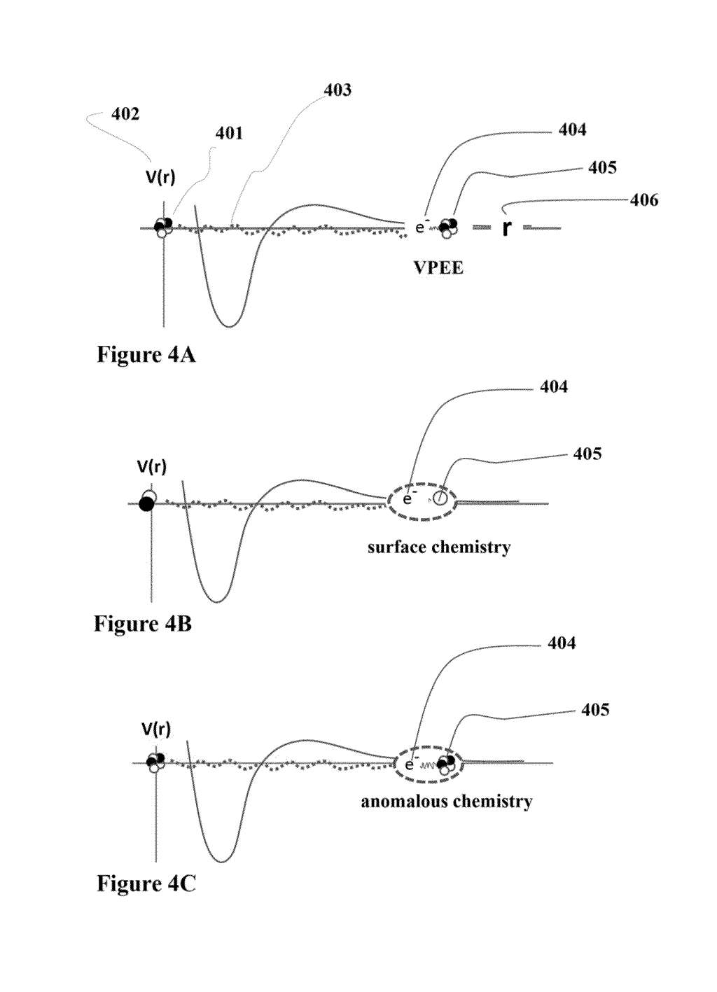

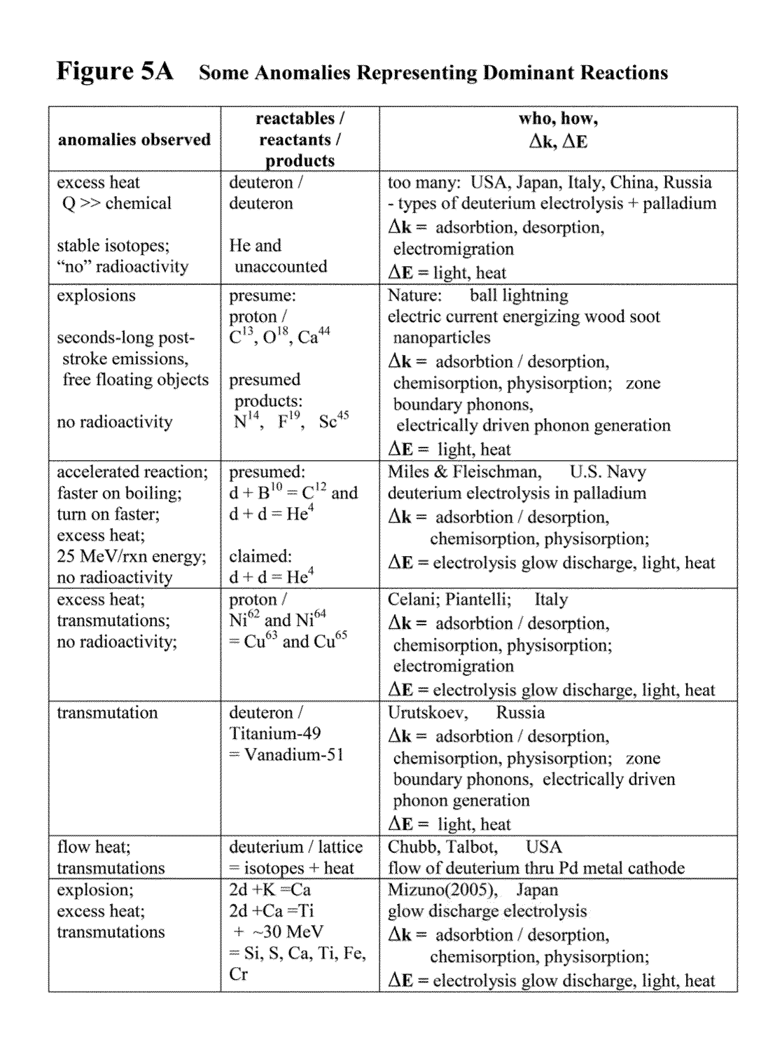

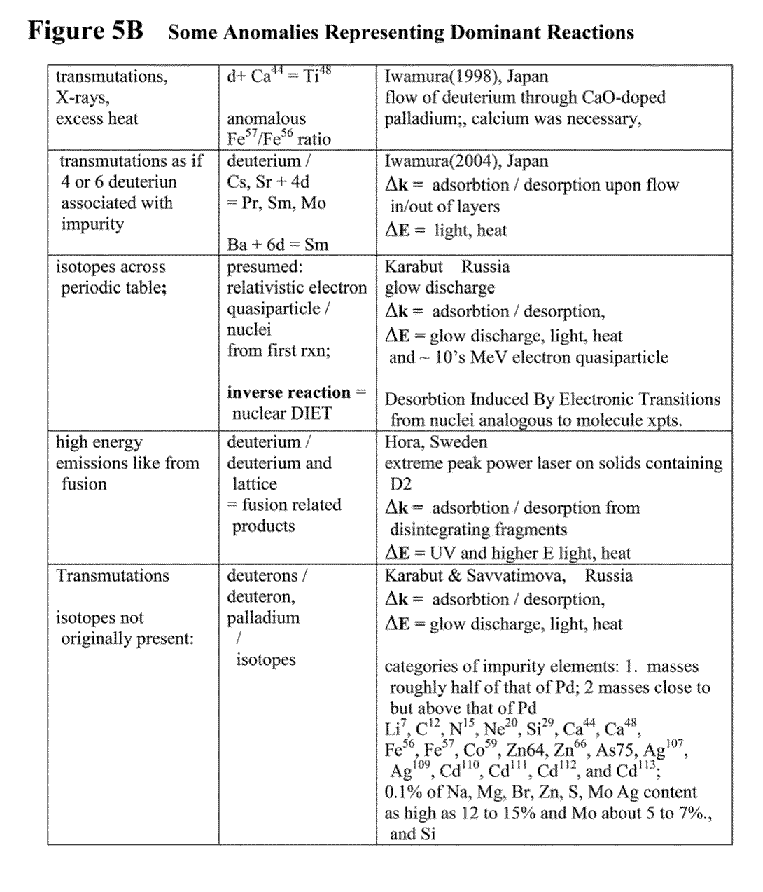

FIG. 4 shows that the arrangement of massive reactants and the electron between them is similar to the arrangement of a hydrogen molecule having only one electron and to the arrangement of nuclei and an atom quasiparticle of anomalous chemistry.

The product of the three body association reactions had exactly the same constituents as the reactants in both the chemical case and the anomalous chemistry case. For example, the product CO₂ of the chemical association reaction has exactly the same atom constituents as the reactants adsorbed CO and O. The CO₂ was in in a low energy state because the energy was measured and accounted for. The energy would become heat within 10 femtoseconds if the diode did not convert it into electricity.

A similar situation is observed in descriptions of anomalous chemistry experiments. The products of the association of reactants, such as a proton with nickel-62, or of two deuterium, or of cesium and deuterium mixtures, always had exactly the same number of protons and neutron constituents. The energy was only observed as heat. The reaction branches appeared to be “proton+e−*+Ni-62 gives Cu-63 and heat; deuteron+e−*+deuteron gives helium-4 and heat; Cs-137+4e−*+4 deuterons gave Pr-145.

The potential energy diagrams of the chemical case, as in FIG. 4A, are essentially identical to those of the anomalous chemistry case, as in FIG. 4B and 4C. The mutually attracting potential 402 between the two massive reactants 401 and 405 is plotted versus the separation 406 between them. They can associate by tunneling 403. The electron between them 404 is associated with a reactant 405.

We should therefore expect the same result when we combine the nuclei of two chemicals when one is an atom quasiparticle and the other is another positively charged nucleus. The result should be a single electron ejected with excess energy typically in the range of 5 to 25 million electron volts, compared to the chemical energy of about 3 to 4 electron volts. In principle, this means we could harvest 25 million units of electrical energy from an electro-nuclear battery or energy source, compared to chemical's 3 or 4.

However, this nuclear process cannot happen at all. The electron has too low a mass. Its Heisenberg repulsive force is higher and greater than the available nuclear attractive force when the electron is confined to a nuclear dimension of the product nucleus. The process can only happen if the electron quasiparticles acquire an elevated effective mass. An elevated effective mass would result in less repulsive force. This reaction branch is “turned OFF” by a low value of effective mass, m*. The chemical reaction of FIG. 2 is “turned ON” by a high value of m*, well above threshold.

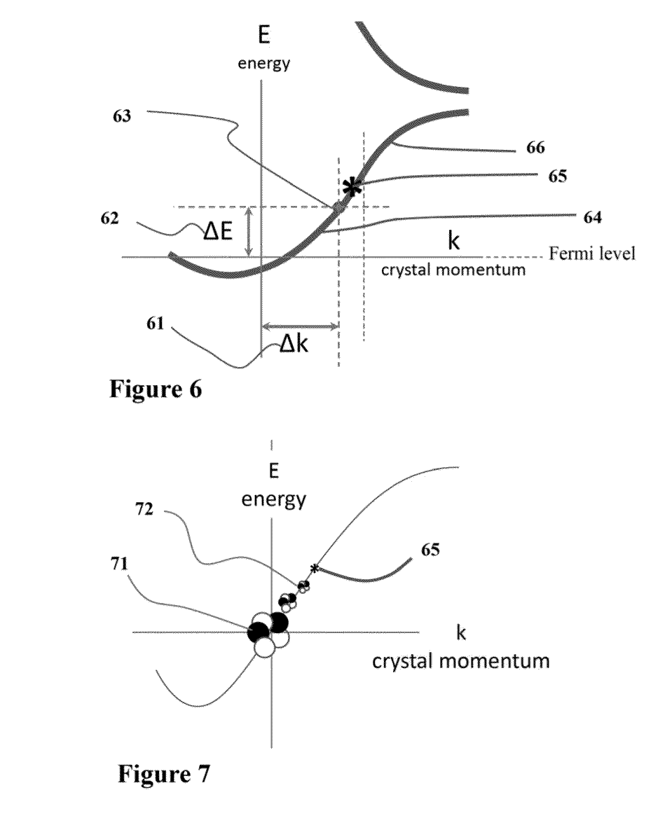

Embodiments elevate the effective mass by adding a targeted amount of crystal momentum Δk and a targeted amount of energy ΔE to place the electron into a targeted region of the E vs. k band structure diagram for conduction band electrons, as suggested in FIG. 6. The effective mass is proportional to 1/curvature and an effective mass between about 20 and 100 is estimated to he required.

Choose the target (k,E) point by selecting a desired effective mass, calculating a curvature, and then selecting the point (k,E) with that curvature. The values shown would increase the effective mass.

As shown in FIG. 7, the transient size of an atom quasiparticle is proportional to curvature, or to the inverse of effective mass. Smaller size can dramatically increase the tunneling probability and therefore three-body association reaction rates. The transients only exist for less than about 10 femtoseconds.

### Discovery of Threshold Effective Mass

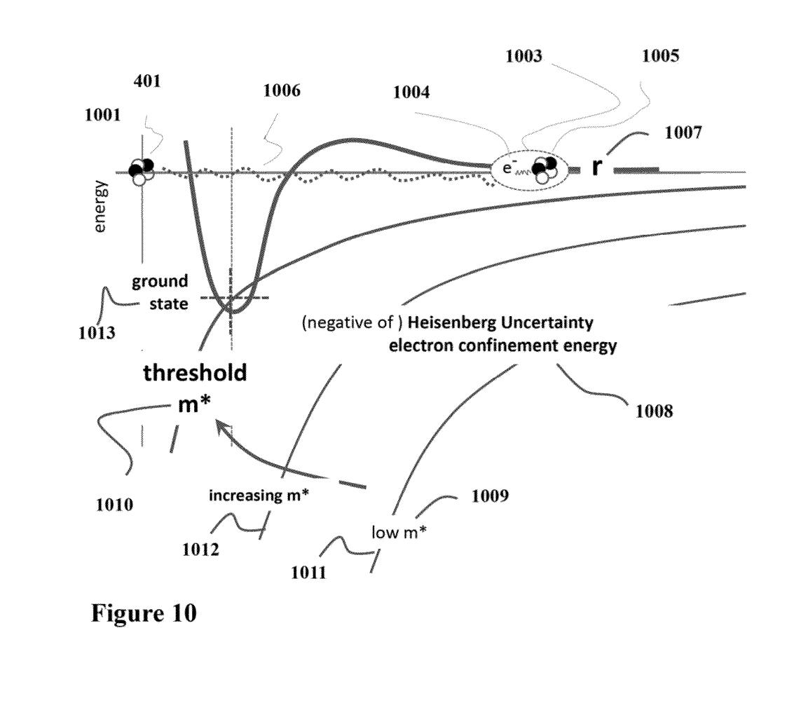

When one models the effect of modifying effective mass one discovers a threshold exists. As shown in FIG. 10, as one increases the electron quasiparticle effective mass 1009 from low or normal to an elevated value, one finds nothing happens until the mass reaches a threshold 1010. At that point the electron is ejected with all the reaction energy and the product is in the ground state. As the effective mass is further increased, the excited states of the product become populated, and the electron is ejected with less than maximum energy. Eventually when the effective mass is large enough, the reaction the internal energy is high enough to produce familiar, two body reaction physics and excited states.

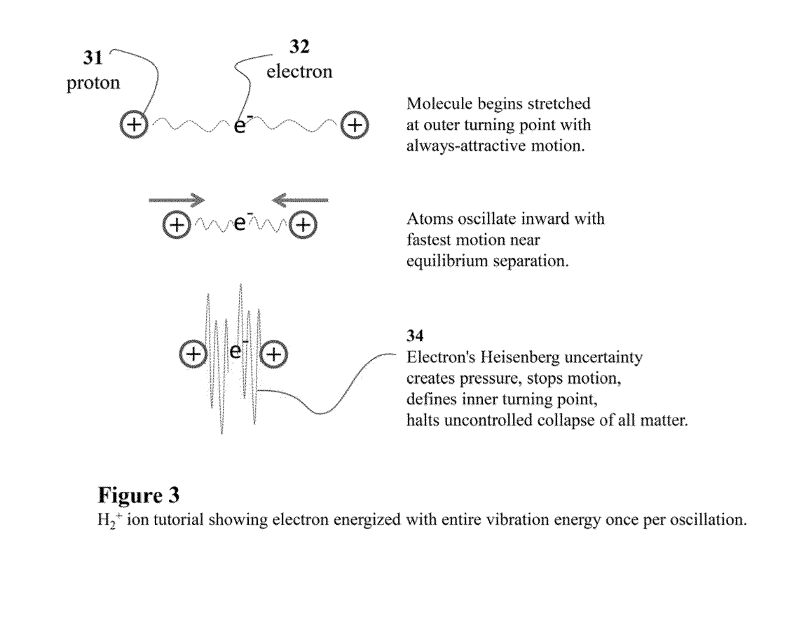

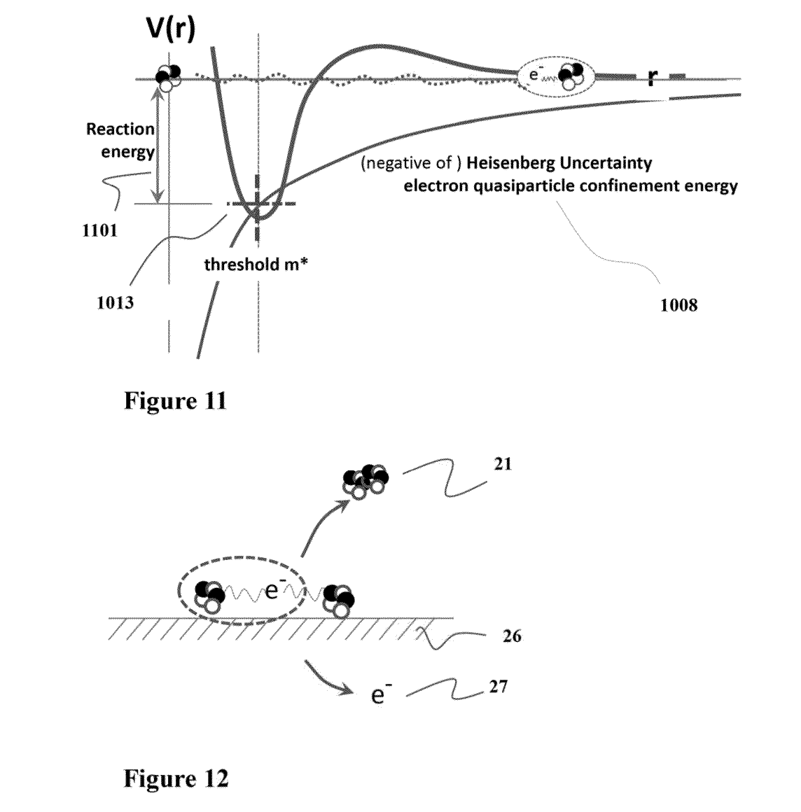

The electron quasiparticle between the nuclei pushes against the reactants due to the Heisenberg uncertainty energy. At threshold, the electron quasiparticle has absorbed all the excess kinetic energy of the two nuclei coming together violently, with the ˜ many MeV energy of a nuclear bond. FIG. 11 combine with the H₂⁺ ion model of FIG. 3 to suggest this. At threshold, the nuclear bond becomes sufficient to bond the nuclei together into a new nucleus. No nuclear reactions occurred. No chemical reactions occurred.

In FIG. 10 a reactant nucleus 1002 in a conductor associates by tunneling 1006 with an atom quasiparticle 1003. The atom quasiparticle is composed of a delocalized electron quasiparticle and a delocalized proton or deuteron quasiparticle 1005. The potential energy between them 1001 as a function of their separation 1007 is the nuclear potential between nuclei. This force is the strong nuclear force between neutrons and protons. The repulsive force generated by the Heisenberg uncertainty energy 1008 is a function of effective mass 1009. The force acts only on the coulomb force of protons. The protons are dragged by nuclear forces. The electron pushes the protons with coulomb, electric forces. The Heisenberg energy 1008 is shown upside down to make it easier to compare the potential energy of the two reactants with the Heisenberg confinement energy, especially at intersections. The energy of such an electron within the range of a nuclear force is relativistic. Estimates including the relativistic nature of the electron quasiparticle imply the threshold for the Heisenberg confinement requires effective masses for the anomalous chemistry case 1010 between ˜20 and ˜100 electron masses.

At threshold, the electron quasiparticle has taken with it the entire reaction energy. The results, as shown in FIG. 12, are then similar to the results of a chemical three-body association reactions.

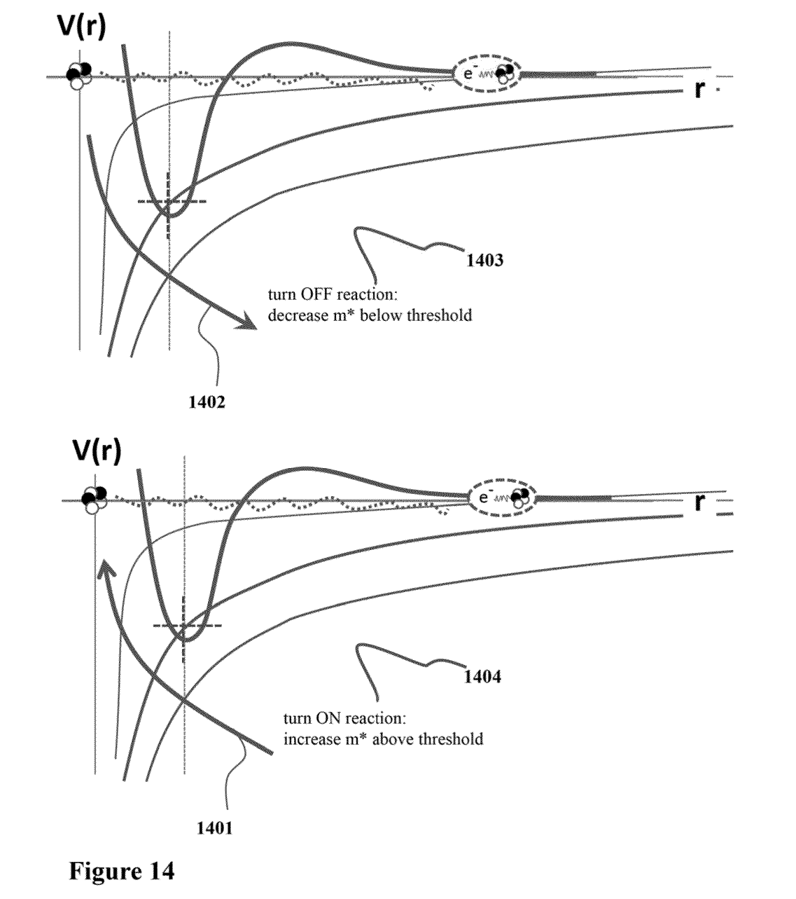

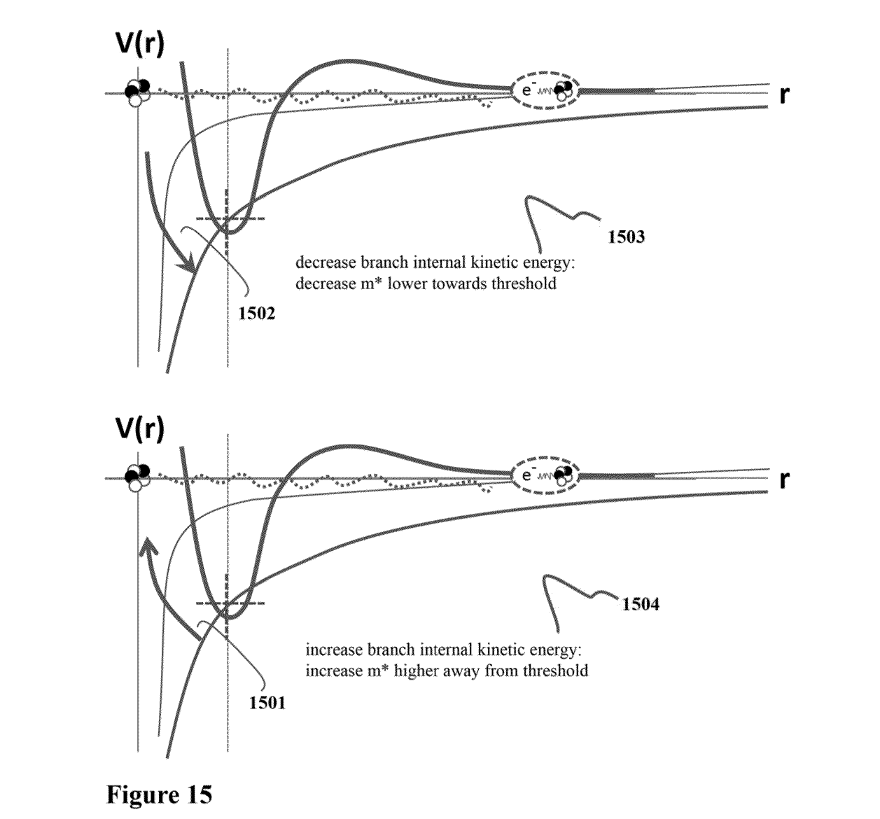

This renders obvious how embodiments of the invention control reactions and their branches. Embodiments decrease effective mass to turn off a reaction and increase it to turn on a reaction, as shown in FIG. 14. The increase or decrease must be from above to below threshold, and vice versa. Control the branch of the reaction by controlling the internal energy available to the reacting masses. Do this by controlling the magnitude of m* relative to the m* at threshold, as shown in FIG. 15.

At maximum m* the reaction has maximum internal vibration energy and produces energetic reaction products, for example, like that observed with laser excited NO in the original VPEE experiments. The product was internally excited to vibration levels from about 1 thru about 10. The threshold m* for the excited state NO reaction is less than 1. An m* less than 1 is typically found in semiconductors.

A key element in embodiments is a delocalized reactant ion. An elevated effective mass electron quasiparticle can combine with a delocalized positive ion and then with another positive nucleus to form a three body, transient covalent bond. As shown in FIG. 9, a covalent bond can be formed with the atom quasiparticle.

Fusion and three body association reactions produce entirely different reaction branches. Two body fusion of a proton and boron-11 results in three energetic alpha particles. A transient, stimulated three body association reaction at threshold produces carbon-12 and about 25 MeV electron quasiparticle.

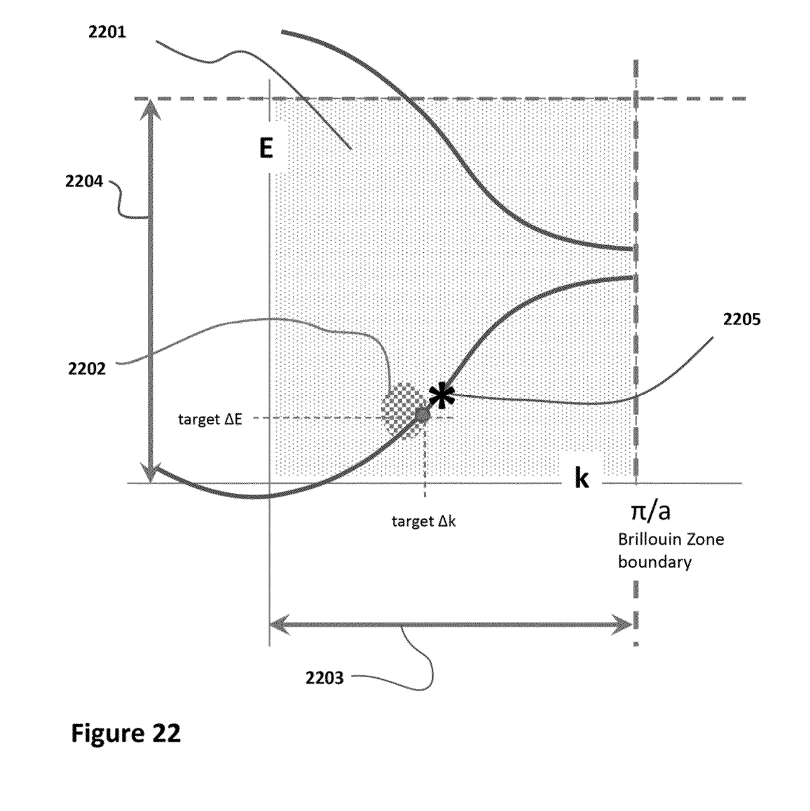

As shown in FIG. 22, a simple method to produce elevated effective mass electron quasiparticles energizes the entire Brillouin zone with a distribution of crystal momentum, and at the same time energizes electrons with a wide ranee of energies. Embodiments use energies sufficient to include the energy region including many E vs. k inflection points, which energies are typicaly under 20 eV. Sufficiently energetic and intense dE injection can populate the conduction band of insulators or semiconductors, transforming insulators into transient conductors. Populating the entire Brillouin zone and energy range inadvertently populates smaller curvature and higher effective mass regions. This can be done in an almost haphazard manner by injecting sufficient energy to cause an entire range of crystal momentum injection and electron energizing. Electric arcs, intense laser pulses, glow discharge and electrolysis are some ways to do this. Other devices to do this include vacuum diodes such as an electron gun, STM tips and nanostructures forming vacuum tube-like devices.

The target value of (k,E) is achieved by injecting (Δk, ΔE) into a region near the desired point (k,E). This region is inadvertently populated by the haphazard injection. All the other regions consume the energy to populate them but are not yet known to produce effects.

The haphazard method has a distinct advantage because a typical band structure diagram has many inflection points. The haphazard method simply accesses many of them, and even each of them.

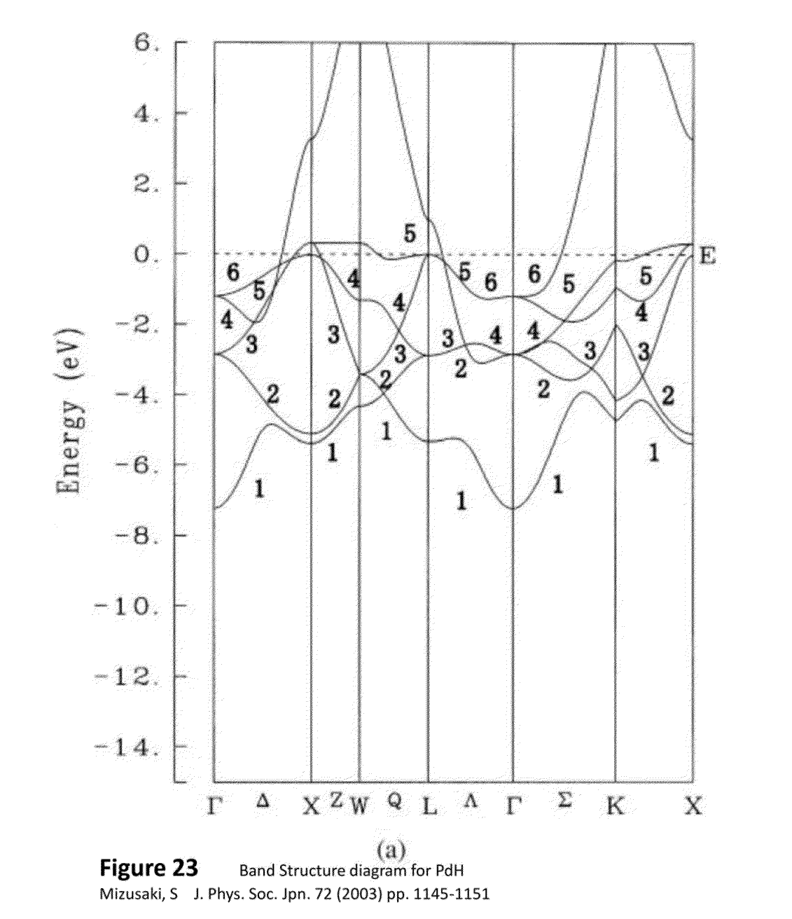

FIG. 23 shows a typical E vs. k band structure diagram for palladium hydride, where one can see many inflection points near the Fermi level.

Embodiments using this haphazard method using electrolysis generating glowing arcs around the electrodes immersed in reactant gas or electrolyte liquid. Embodimens use the pulsed discharges through metal foils immersed in reactant. These activate the desired regions of (k,E) at the expense of energy efficiency.

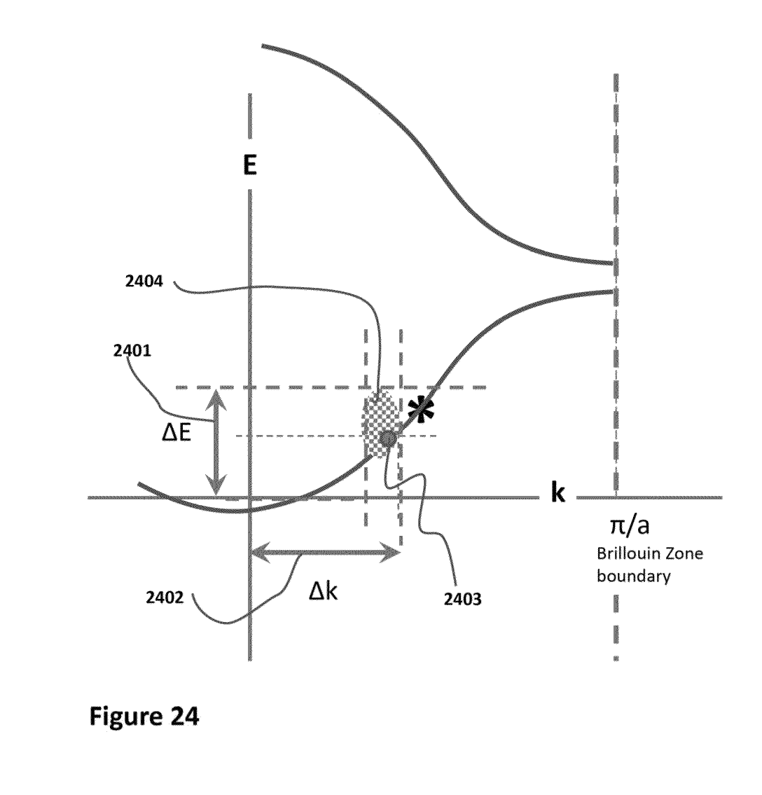

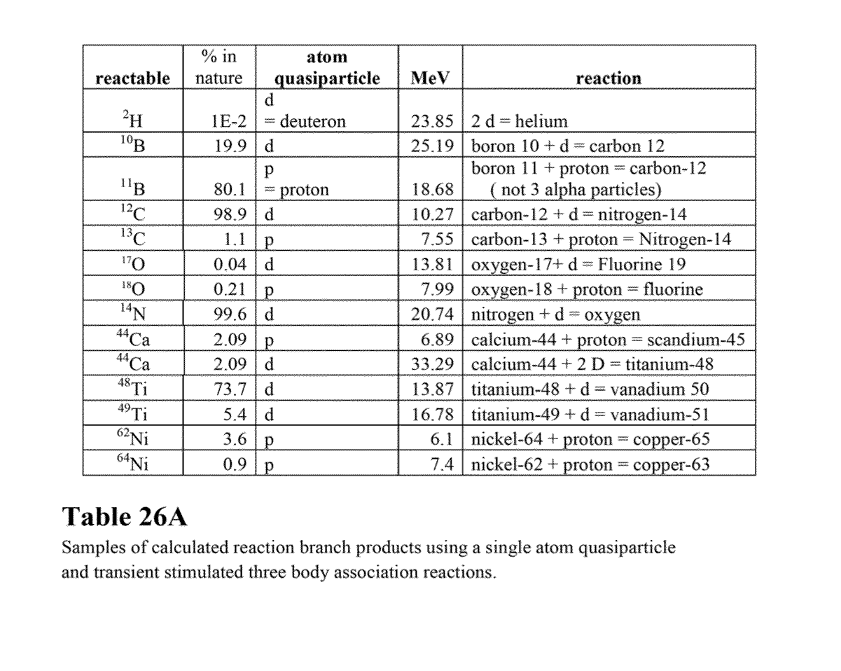

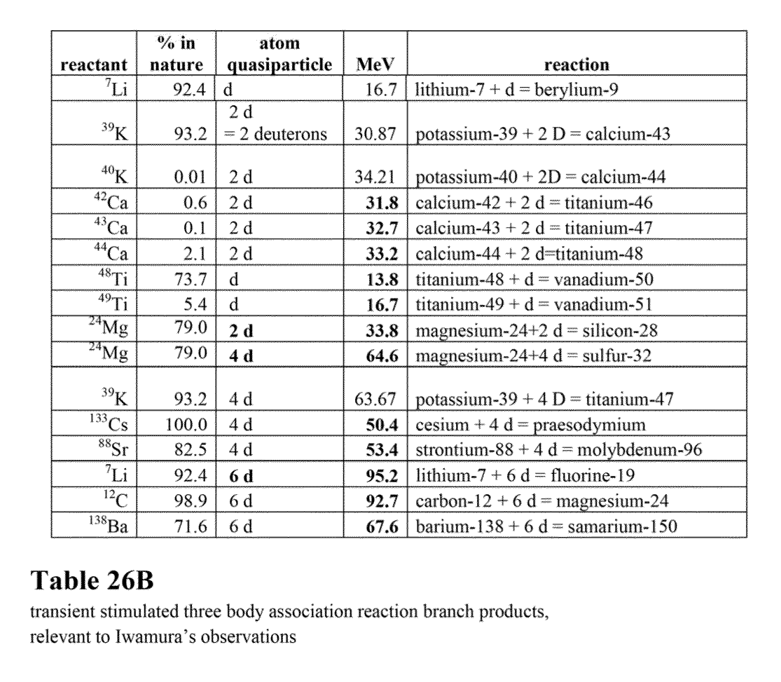

FIG. 24 shows a segment of a band structure diagram where a targeted energy ΔE and a targeted momentum Δk are injected near the desired (k,E) point. The injection energy ΔE is higher than the desired ΔE because the electron quasiparticle energy tends to thermalize an electron energy at each inelastic collision. Therefore a point injection decays to a smear. The optimum is a choice driven by a function of many engineering variables.

It would be advantageous to be able to use reactants and reactables with a high affinity for negative charge. A positive, low mass quasiparticle is required between them. Embodiments would use a semiconductor in which a hole is the positive quasiparticle and reactants with a negative charge or affinity for negative charge can be delocalized. It is recognized that positive real mass ions may act like negative particles when excited to higher energy portions of the E vs k band diagram for the positive ions. A corresponding real electron may act like a positive particle in a similar way, for example, at k values above the inflection point.

The crystal momentum and energy injection is a transient process and only lasts as long as the quasi particles retain their properties. This time is when electrons in the conductor are “ballistic,” meaning “before they collide with something,” and is of order the “mean time between collisions,” which is of order 1-10 femtoseconds for conduction electrons in metals. The corresponding mean free path is typically of order 1-50 nm.

The crystal momentum value is also transient because it energizes phonons. The phonon energy also changes when phonons propagate and hit something. Energized phonons will exist for a time of order 500-20,000 femtoseconds. A particle with dimension sufficiently small that the highest energy phonon is not activated lengthens the time during which electrons cannot dissipate their energy to phonons. It is a tradeoff returning longer electron quasiparticle lifetime. This dimension is also of order 5-15 nm in many materials.

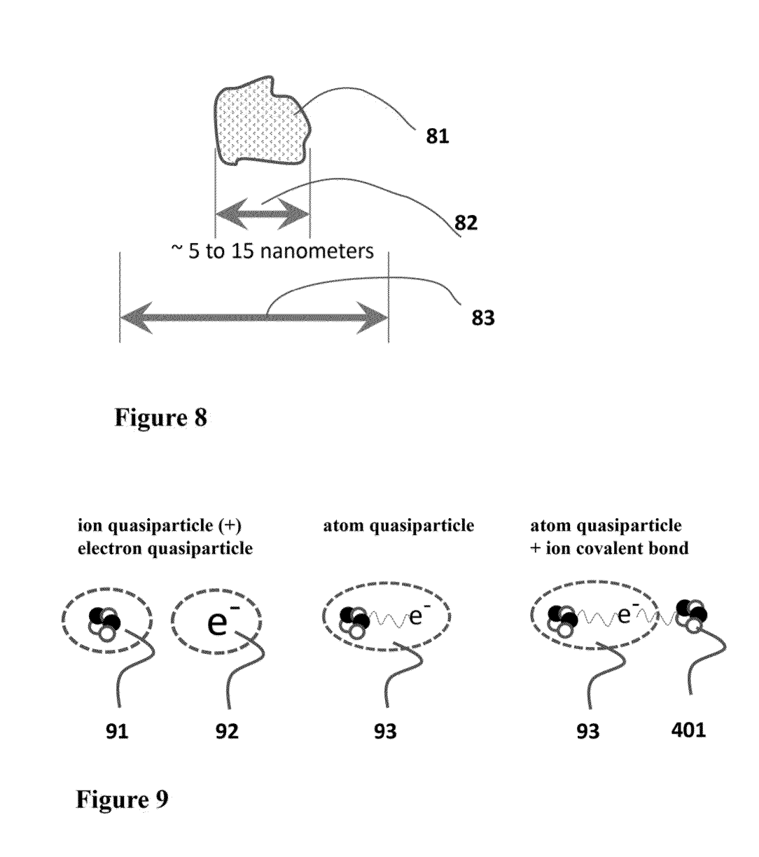

As shown in FIG. 8, each of these particle size constraints 83 are approximately in the same range. Embodiments choose the reaction particle's 81 minimum dimension 82 to be less than some value 83 approximately given by electron and phonon mean collision times, mean free paths and quantum calculations. An approximate upper limit is about 15 nm.

### Elements of a Device

The key elements of a practical device include reaction particle participants, a pump system and an energy sensor system.

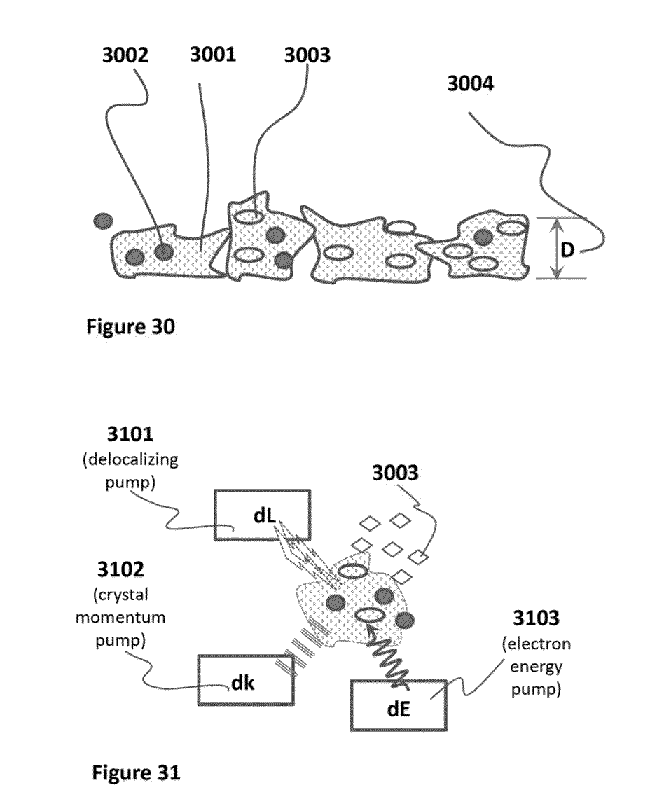

As shown in FIG. 30, reaction particle participants include one or more conducting reaction particles 3001, reactants 3002 in or on one or more conducting reaction particles that can be delocalized to be ion reactants in the conducting reaction particles, and reactables 3003 in the conducting reaction particles. Choose a set of reactants and reactables such that at least two in the set can form a stable product in an associated state.

Each of the conducting reaction particles have a minimum dimension, D, across the conducting reaction particles 3004. In one embodiment, the distribution of the minimum dimension across the particles of the one or more conducting reaction particles includes particles having the dimension across the particle less than a maximum, nominally 15 nanometers. The optimum dimension is a function of many variables and is not under 15 nm for many situations of interest. In other embodiments, choice of targeted dk and dE may Obviate this limitation.

A pump system, shown in FIG. 31, includes a delocalizing pump 3101 to inject energy dL to delocalize reactants, a crystal momentum pump 3102 to inject crystal momentum dk into one or more conducting reaction particles, an electron energy pump 3103 to inject energy dE into a conduction electron of one or more conducting reaction particles, and a tailored crystal momentum injection material 3104.

Configure the electron energy pump 3103 to inject at least the energy of a chosen, target inflection point. Configure the crystal momentum pump 3102 to inject at least the crystal momentum near to the inflection point. In both cases, electron and phonon thermalization allows “near to” to mean in the same Brilloin Zone and corresponding to an energy or energy derived from momentum to be greater than 5 kT less than the desired value, where T is temperature and k is Boltzman's constant.

The delocalizing pump, the electron energy pump and the crystal momentum pump can in some configurations be accomplished with one and the same device and method. Many methods are known and have been used in anomalous chemistry experiments.

Many methods to fabricate tailored crystal momentum injection material 3104 can be used, including using reactants, electrolytes, reactables, tailored materials, and even parts of the reaction particle itself. For example, the titanium foil used by Urutskoev disintegrates and can produce byproducts which react, adsorb and desorb, chemisorb and physisorb on a titanium or titanium dioxide reactant. Tailored crystal momentum byproducts include heavy water, water electrolysis metal and metal oxides resulting from the disintegrating, high current pulses.

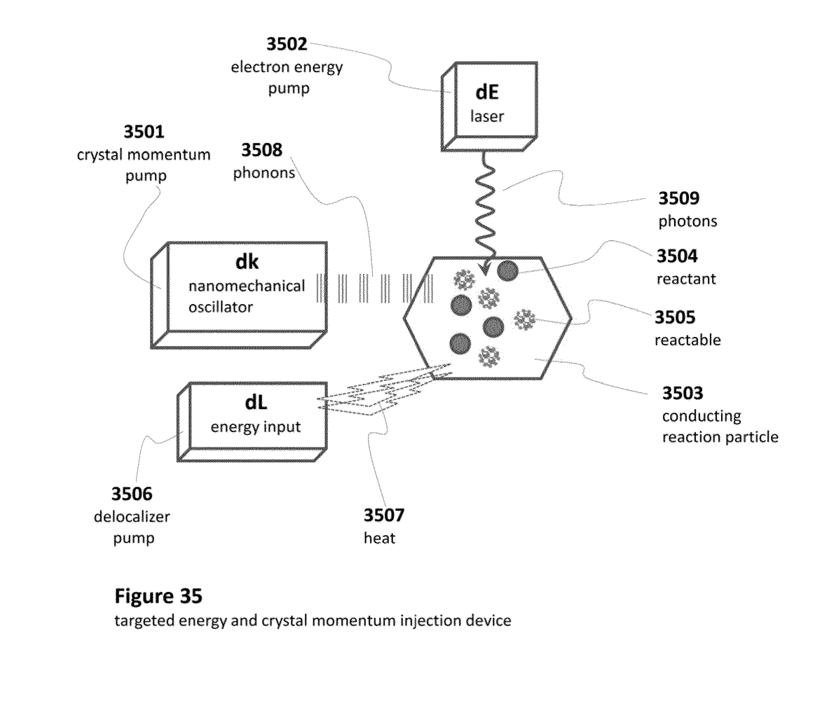

Embodiments designed to target dL, dk and dE values to enhance efficiency include a crystal momentum pump dk 3501 to inject phonons 3508 into a reaction particle 3503 containing a delocalizable reactant 3504 and a reactable 3505, sketched in FIG. 35. A delocalizer pump 3506 injects energy 3507 such as heat to delocalize reactant 3504. In an embodiment, after delocalization heat 3507, a nanomechanical oscillator 3501 in contact with the conducting reaction particle injects phonons 3508 with crystal momentum near to the desired dk value. Then a laser 3502 tuned to near the desired dE value injects photons 3509 to energize electron energy.

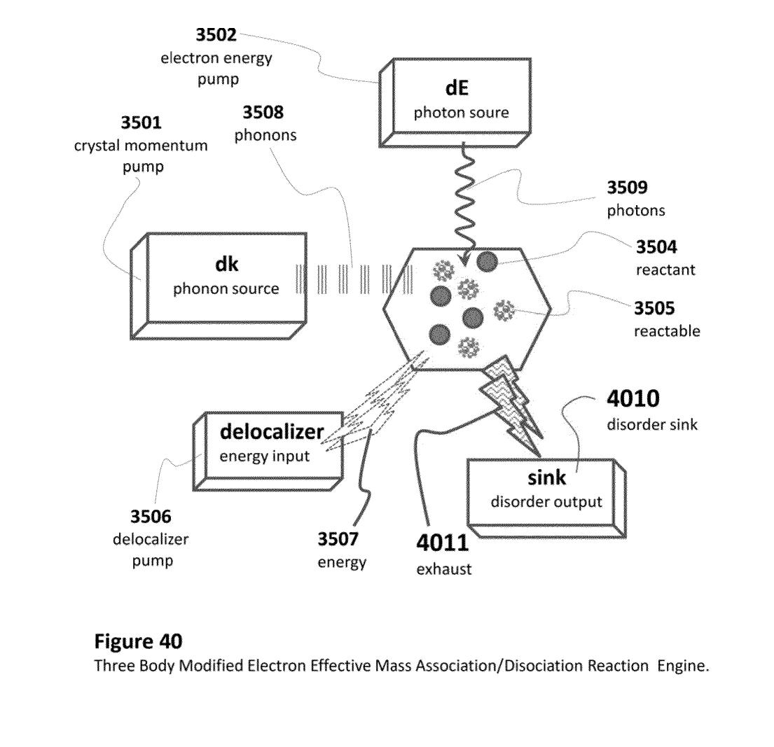

A complete system to control reaction branches, reaction rates, and association or dissociation processes includes a sink for exhausts such as heat and reaction products, as shown in FIG. 40.

An optical source can be used as an electron energy pump. A pulsed laser can provide not only tailored energy values but also sequenced pump timing. An efficient electron pump adds electron energy after crystal momentum has been injected and during the lifetime of the resulting energized phonons. The appropriate pulse durations are a function of specific configurations. The pulse durations are typically orders of magnitude shorter than the time between collisions of gas molecules such as air or vaporized reaction participants and vaporized materials surrounding reaction participants.

The injection of electron energy can be done in many ways. For example, a forward biased Schottky diode has been successfully used to inject 1-5 volt electrons into a nano-meters thick surface exposed to reactants, specifically for the (somewhat failed) purpose of causing changes in reaction rates. The electron energy is directly related to the band discontinuities, and manifests as a Schottky barrier or band discontinuity. Other similar solid state devices include a forward biased pn junction and a metal-insulator-metal junction, which have also been used for hot electron injection.

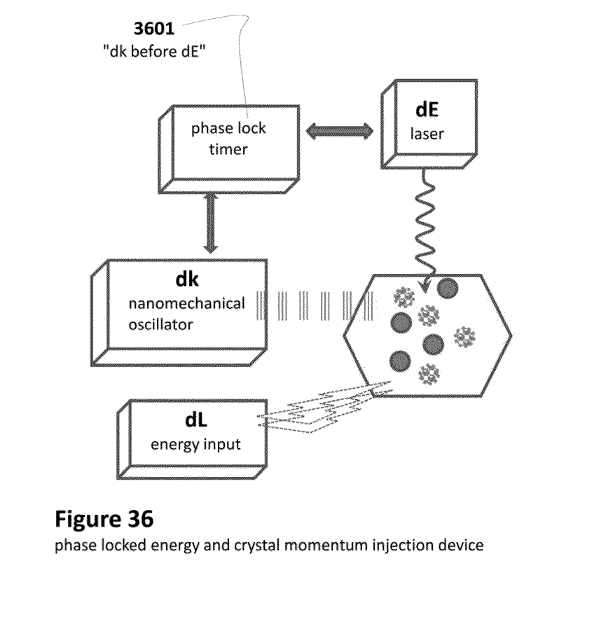

An embodiment sketched in FIG. 36, includes a phase lock system 3601 between the dk pump and the dE pump to tailor the electron energy injection to occur at an optimum phase of momentum waves injected. Another embodiment further includes an electron energy pump to transform an insulator or semiconductor into a transient conductor. This permits a much wider range of materials to be used than simply conducting particle.

The energy sensor system includes an sensor configured to detect and/or measure one or more emissions by any reactions that may be stimulated. Note that an engine or electric generator is a sensor with quantifiable output 326.

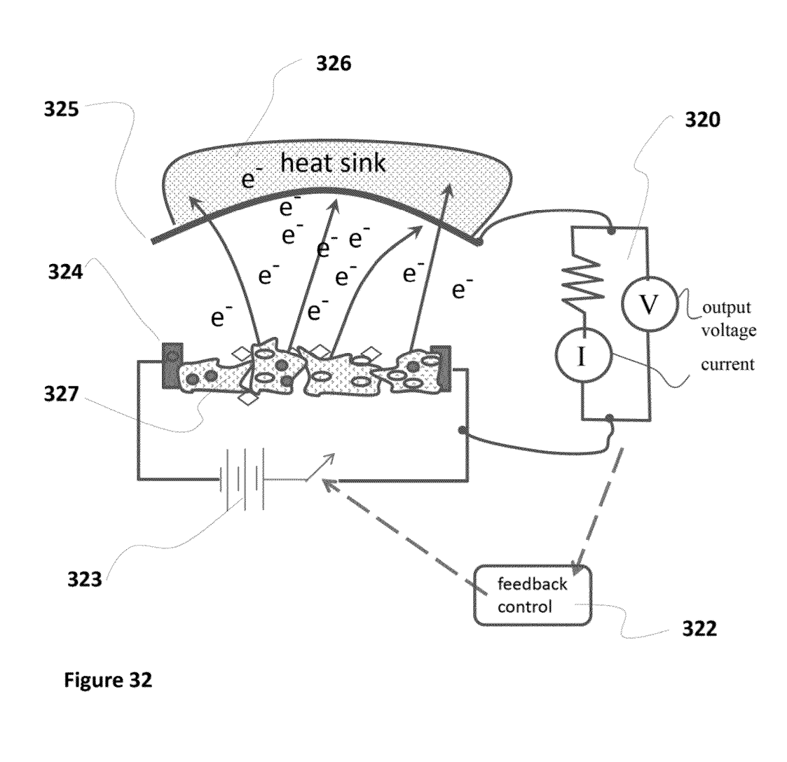

An embodiment sketched in FIG. 32 showing a thermionic emission energy sensor and electric generator requires a heat sink 326. An energy sensor can provide feedback signals 322 to control the pump processes.

An electron energy pump can comprise an electric energy source 323 configured to pass an electric current or pulsed current through the reaction participants 327. An energetic reactant and reaction particle combination in one embodiment includes reactants including deuterium and a reaction particle including palladium.

Examples of some products of three body association reactions are shown in FIG. 26. They are different from familiar two body fusion reactions. An energetic reactable/reactant atom quasiparticle in an embodiment includes combinations such as in FIG. 26A, for example, (boron-10, deuterium), (boron-11, proton), (carbon-12, deuterium), (carbon-13, proton), (calcium-44, proton), (oxygen 17, deuterium), (oxygen-18, proton).

Diode energy converters should be located within the range of emitted electrons. A semiconductor- or metal-insulator-metal diode may be directly connected to a reaction particle. Pulsed operation in conjunction with a heat sink ensures that the energy converter temperature remains lower than the effective temperature of the collected electrons. Pulsed pump systems therefore have the advantage.

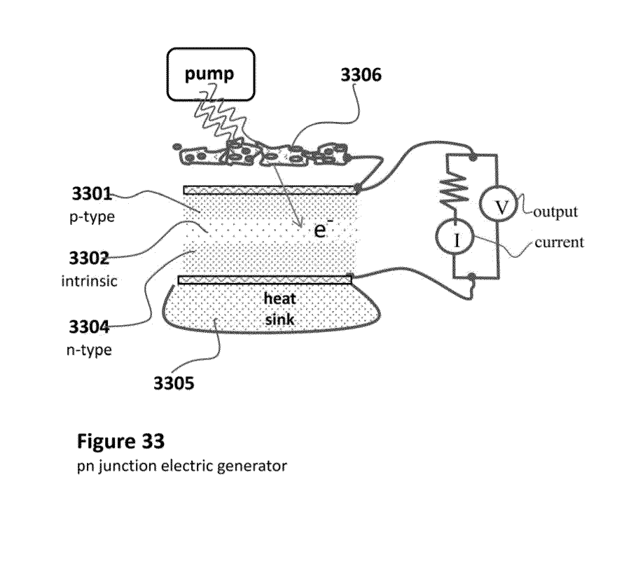

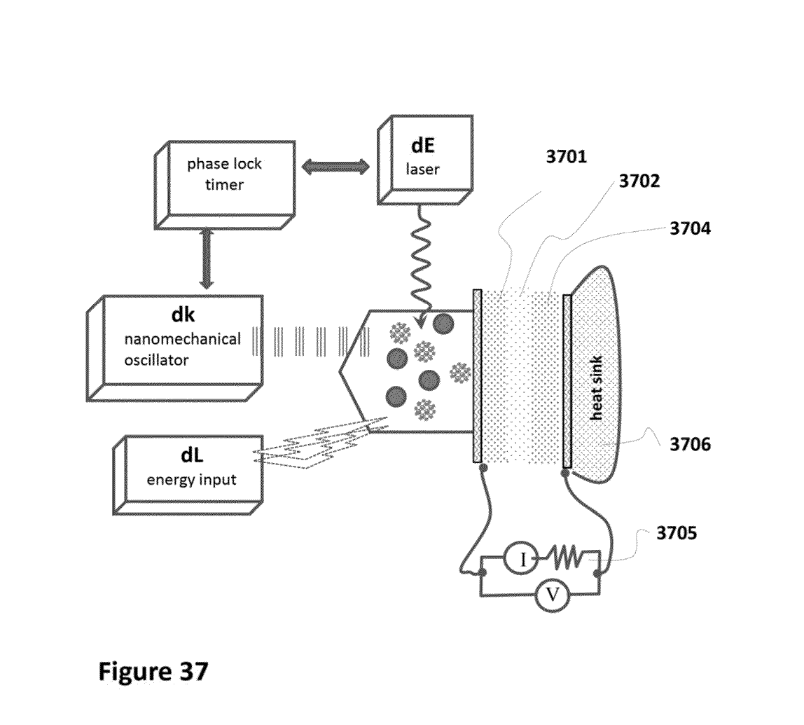

As sketched in FIG. 33, a pn junction diode energy converter has the p-type region 3301 accessible to the emitted electrons. FIG. 37 depicts a similar device. An extended intrinsic region 3302 between p-type 3301 and n-type 3304 regions is common and useful. A Schottky diode energy converter is similar to a pn junction converter and typically uses a metal as the p-type. The high expected energies permits use of materials with large bandgaps, for example bandgaps in excess of 5 eV. An average electron energy far above bandgaps and Schottky barriers permits a wide range of semiconductors, including those that operate at elevated temperatures such as diamond, SiC, and metal-insulator-metal capacitor diodes. As has been observed in photovoltaic semiconductor energy converters, quantum yields in excess of 100 percent are possible, where one energetic photon, or electron, energizes many, less energetic photons, or electrons, and the less energetic photons or electrons charge the diode energy converter. A heat sink 3305 is required to extract electricity. Reaction participants 3306 may need to be physically isolated from and electrically connected to semiconductor junctions when the pump would interfere with the junction.

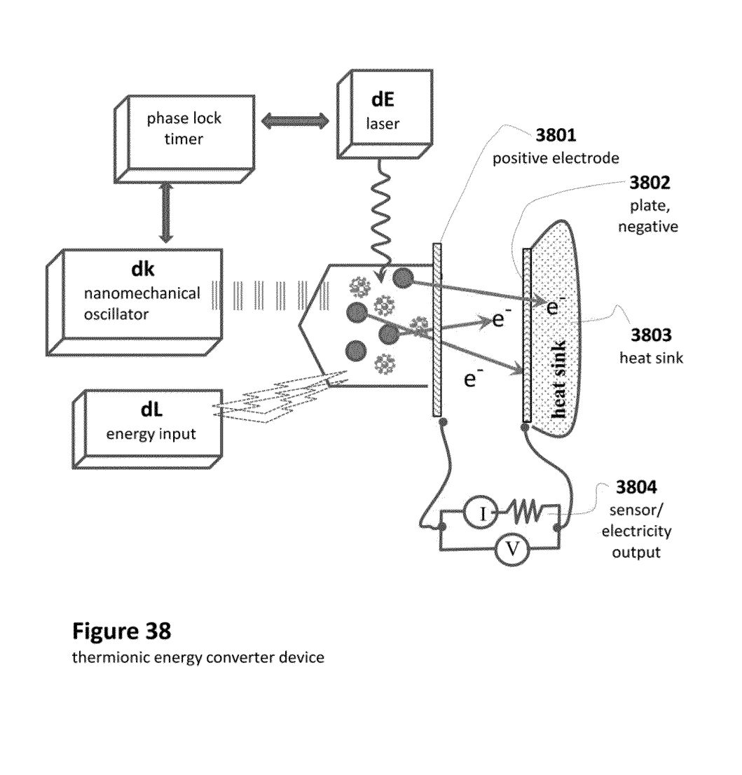

FIG. 38 shows a similar device using a thermionic energy converter.

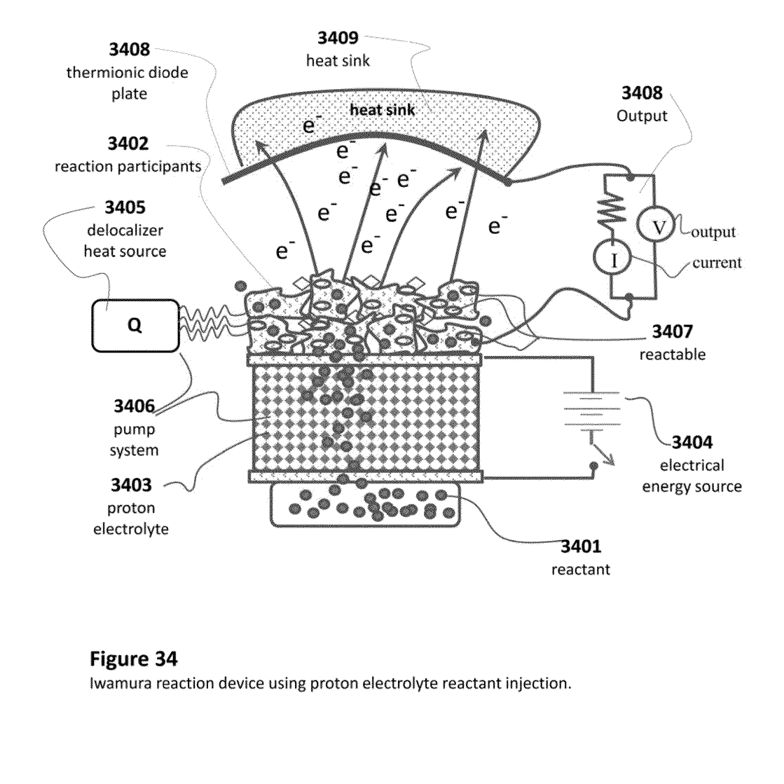

FIG. 34 sketches a reaction system using an Iwamura-type reactant flow system. Reactant deuterium 3401 is injected into the reaction particle participants 3402 by a proton electrolyte 3403 energized by an electrical energy source 3404, shown as a pulsed system. The flow direction is controlled by the polarity. Choosing flow direction to be into the reaction particle participants can maximize the instantaneous density and therefore reaction rate. The electrolyte 3403 and heat source Q 3405 provide pump functions 3406. Reactables 3407 may include at least 0.7% boron-10. When protons replace deuterium as reactant 3401, reactables 3407 may include boron-11, carbon-13, oxygen-18, calcium 44 dopants to name obvious reactables. A thermionic diode plate energy converter 3408 including a heat sink 3409 can serve as the sensor by delivering an output 3408 electrical signal.

A mass energized by emissions can also serve as an energy sensor. For example, the thermionic diode 3408 and heat sink 3409 can be replaced by the working fluid of a turbine engine or the propellant of a rocket, both guided by aerodynamic flow controls such as nozzles and diffusers. The sensed output 3408 could then be momentum and/or energy density of the flow.

In embodiments, forming the reaction participants to be thinner than the distance penetrated by the energetic emissions can minimize energy losses. For example, an approximate monolayer of 5 nm average dimension D of reaction particles can be used both as reaction particle and as electrode for a proton electrolyte.

Using a proton electrolyte to inject reactants and/or as a delocalizer is useful, especially if used in a pulsed mode.

Useful tailored crystal momentum materials include water, heavy water, hydrogen sulfide, conductors used for hydrogen storage, and electrolytes.

Embodiments using an efficient injection sequence first inject reactants, delocalize them, add crystal momentum, and finally add electron energy, in that order. This sequence starts with the longest process and ends with the shortest. The electron energy will therefore be immersed in the desired crystal momentum.

It is useful to use separate delocalizer, electron energy injector, and crystal momentum injectors. One way to do this places reaction particles on a nonconducting substrate to support the particles.

A device can increase the efficiency of crystal momentum addition by including materials that adsorb, desorb, chemisorb or physisorb with the reaction particles at a temperature lower than the melting point of the reaction particles.

Experiments in anomalous chemistry suggest that an effective pump system discharges sufficient electrical energy in a pulse to destroy or vaporize some components of the reaction region. A useful device includes a pump that may operate destructively. A natural phenomenon with characteristics apparently matching the key elements of a transient, stimulated three-body association reaction is bail lightning. Reactant candidates include delocalized proton (H), delocalized electron, and carbon-13 in glowing carbon conductors, for example, from tree wood soot energized by the electric pulse of a lightning stroke.

In one possible reaction branch, the resulting highly energetic electron would be ejected from the reaction region as a relativistic electron quasiparticle. Such electrons were never acknowledged. The relativistic electron quasiparticle, born with low momentum and energy typically between 5 MeV and 25 MeV, in the vicinity of the product or nearby nuclei may cause the electro-nuclear equivalent of Desorption Induced by Electronic Transitions (DIET), summarized by Frischkorn. This would result in apparent fissions where groups of particles are ejected in relatively low internal energy states, exactly as observed in DIET. The result is the inverse of a three body association reaction, which is a stimulated three body dissociation reaction. Experimental evidence supporting this are observations of isotopes with atomic mass number less than the mass of the heaviest isotope.

One can also expect excited states not readily accessible by two body reactions and with unfamiliar lifetimes and reaction products.

in another possible reaction branch the electron wave functions making up the electron quasiparticle will dephase into the constituent electrons making up the quasiparticle. Dephasing is estimated to occur in a time less than the mean time between collisions, tau_mfp ˜10 femtoseconds.

Using a Warmier function representation where all the electron wave functions couple to form a localized electron quasiparticle, dephasing can result in each electron sharing the total energy. Because the number of conduction electrons in a particle of 10 nm dimension can be Ne˜100,000, the dephasing time can be as small as tau_mfp/√Ne, ˜2E−17 seconds. After some time between 2E−17 seconds and 1e−14 seconds the average energy of each electron can become the shared value of order “Reaction Energy”/“number of electrons”. This is the basis for the simplest energy conversion embodiments. In this reaction branch, all the electrons involved collide at a rate given by the mean time between collisions, and complete thermalization can occur during the time of one collision.

An estimate of the energy per electron after a dephasing time uses a cubic particle with “radius” equal to about one electron mean free path. With about 3 Pd atoms per nanometer and between 2 and 10 electrons taking part in the conductivity, there are of order “2 to 10 electrons”×cube of “2×5 nm radius×3 atoms per nm”, or between 54E3 and 270e3 electrons that could share the reaction energy. Sample energy ranges include ˜25 MeV for a d−e*−Boron10 reaction, ˜23 MeV for d−e*−d, ˜18 Mev for p−e*−boron-11, ˜16 MeV for d−e*−Ti49 and ˜7 MeV for p−e*−Ni64 reaction. These sample the most quoted reactions.

In the limit, all the electrons take part and the energy ranges therefore between between ˜26 and ˜460 eV/electron. The initial high voltage, single electron current can dephase within one mean collision time to low voltage, high current, with 50 to 250,000 electrons having from 26 to 460 electron volts energy. These energies are compatible with solid state energy sensors and converters. An effect resembling this has been observed in anomalous chemistry.

These energies are above known work functions in metal nanoparticles. Work functions range from about 1 eV to about 6 eV in metals. All electrons with energy above the work function will escape the particle as soon as energized if the dimension travelled is less than the mean free path of the given electron. The result would appear to be an electron explosion, with the particle retaining an equal positive charge.

Note again that in this branch, the dephasing can complete in a time less than one mean collision time, unlike simple electron-electron collisions, because the Wannier function can use as many electrons as the number of the electrons in the particle to participate in the effective mass. This branch and energy result is consistent with and predicted by electronic friction by IDS Gumhalter et al.

In another possible branch, the energy is shared among the number of electrons given by the effective mass, in the range ˜50 to ˜100 electrons. The electron energy would then be in the range from about 7 MeV to 25 Mev in about 50-100 electrons, or between 70 keV and 500 keV.

As suggested in FIG. 32, a thermionic diode with cathode 324 and anode 325 connected to a conducting reaction particle can collect any of the above energies as a potential when connected to a heat sink 326.

A highly energetic, 5 to 25 MeV electron quasiparticle emitted from a three body electro-nuclear association reaction can also collide with and energize other electrons in the conductor much faster than it can lattice atoms. These collisions dissipate energy into other electron quasiparticles in the conductor. This reaction path also results in a spray of energized electrons sharing the total energy. In one embodiment, the energy can be the entire 5-25 MeV electron quasiparticle energy. An embodiment would convert the apparent energetic electron explosion into electrical potential.

When a distribution of elevated effective mass electron quasi particles are created in a region including delocalized ions with more than one positive charge it is expected that the heavy electrons can, transiently, quickly replace all the electrons of the ion. The resulting bare, positive nuclei may also take part in transient, stimulated three body electro-nuclear association reactions. Adamenko may have observed this in his copper targets. Bare carbon nuclei would associate to Magnesium. Ball lightning may be doing this. The reaction may therefore include multi-body association reactions where multiple modified effective mass electrons take part and are emitted. Embodiments would sense these electrons.

A person having ordinary skill in this art is well versed in VPEE, quantum mechanics of effective mass at inflection points, chemical physics of nanometer dimension particles, surface catalysis reactions, desorbtion induced by electronic transitions, nuclear reaction pathways, and in known conventional methods of energy conversion. This person therefore recognizes that the direct charge ejection can also result in energizing and pressurizing any material, mass or working fluid.

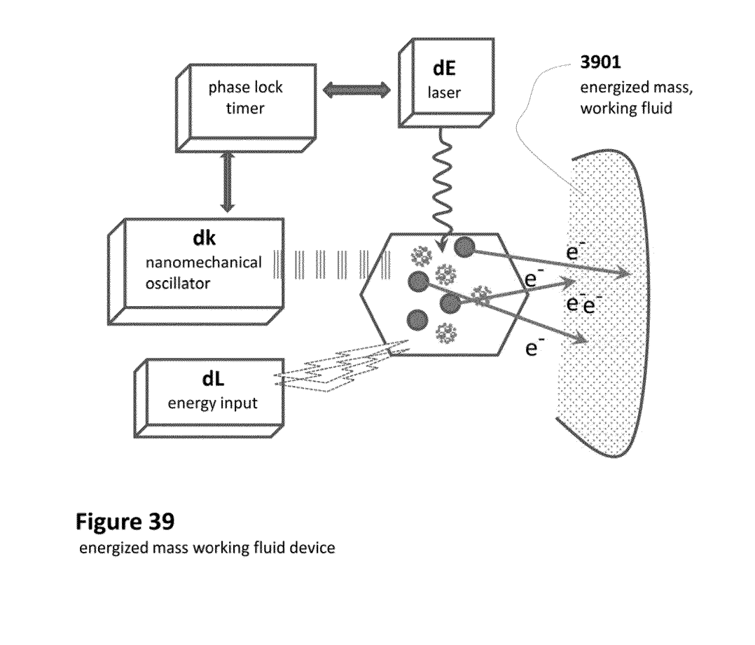

Rocket propulsion may use stimulated three body electro-nuclear association reactions to energize whatever propellant is available in a thermal rocket. Lunar regolith, asteroidal regolith, dust, ice, water, steam, comet dust hydrocarbons, and the atmospheres of planets and moons can be used as a rocket propellant. Hydraulic fluids can be energized in many ways and are exceptionally weight efficient in application of hydraulic pistons and hydraulic rotary engines. Gasses used in turbine engines may be energized. These are only a few, more obvious examples and are shown generically in FIG. 39, showing an energized mass 3901.

### Methods to Tailor Δk

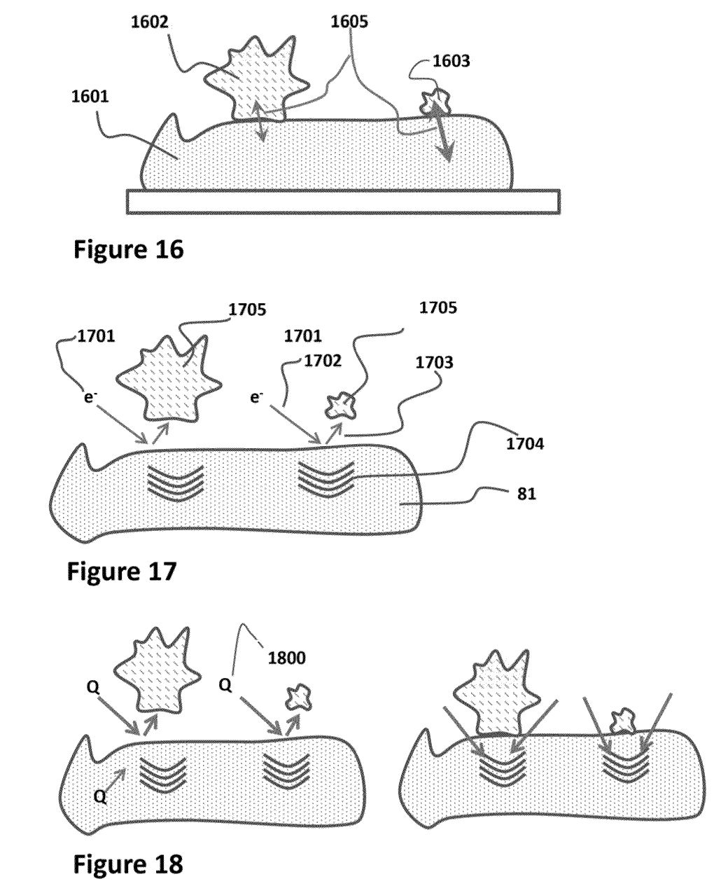

Embodiments use methods to tailor the value of the injected crystal momentum. FIG. 16 shows a particle with both a larger and a smaller molecule or atom adsorbing and desorbing. Each injects crystal. momentum into the lattice. The classical momentum is given by

p=√(2 m E).

where p is the momentum, m is the adsorbate mass and E is the adsorption energy. This suggests that any entity with the same m−E product will impart the same momentum. There are a plethora of materials from which to choose, each with a different adsorption/chemisorption/physisorption energy E and molecular mass m. Various methods to cause adsorption and desorption are well known to those with ordinary skills in the art.

For example, the adsorption energy of hydrogen or deuterium adsorption releases ˜4 eV, and has mass ˜1 or 2. This imparts more than 50 times the momentum of the first Brillouin Zone (BZ). It would be advantageous to decrease the energy to the range of ˜100 millivolts, like that of the first BZ, and incidentally like that of physisorptions.

FIG. 17 shows that hot electrons can cause desorption when the electrons have sufficient energy. The desorption can be efficiently initiated by femtosecond electronic energizing processes. Such desorption can complete in less than ˜1000 femtoseconds. A femtosecond laser is usually used. Frischkorn (2005) summarized this process.

Additionally, when the energy is relativistic with energy exceeding the electron rest mass and when the reaction particle is a nucleus, this can result in desorption of collections of stable isotope subsets of a nucleus. These are not fission products. Requiring energy, they are ejected by a DIET process.

FIG. 18 suggests that electrolysis, heat, light and gas flow through the particle can all cause adsorptions and desorptions.

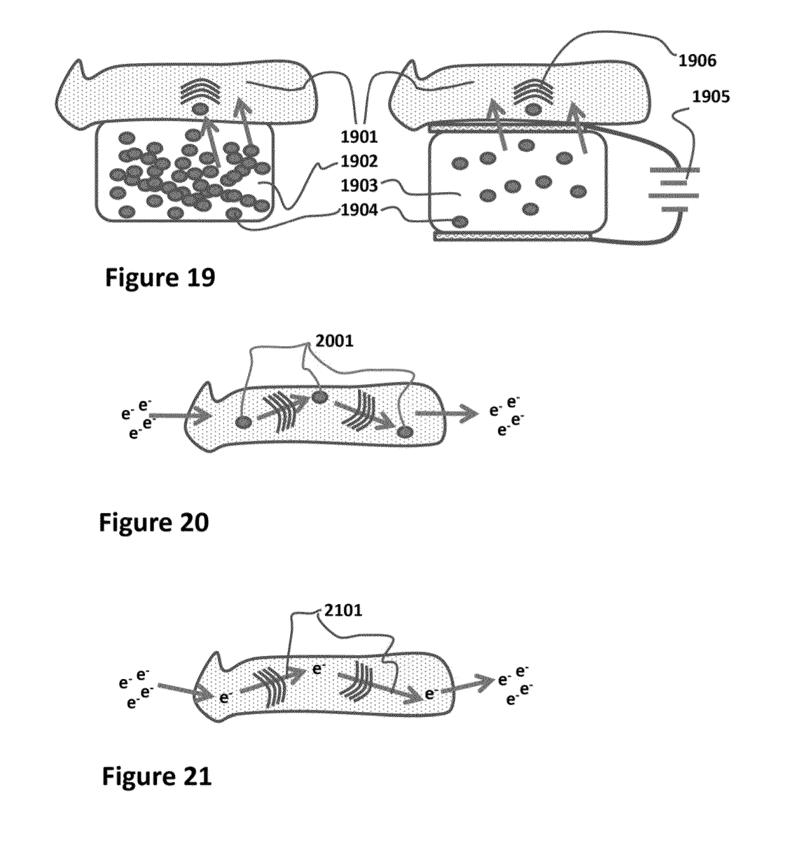

As shown in FIG. 19, gas flow through many materials is believed to occur as ions, especially through those used to store hydrogen. A pressure difference across the particle causes ion flow. The atoms dissociate and lose electrons upon entry into the reaction particle and associate and regain electrons upon leaving. When the particle is warm enough, the ions can move by diffusion, and some may move as delocalized entities. This temperature is typically above 120 Celsius in palladium, and may be higher for nickel. Many materials exhibit this kind of flow. Nanotubes and TiS2 are candidates. Electrolytes have been proposed and used for this purpose.

FIG. 20 shows Δk, injection by electromigration.

FIG. 21 Shows Δk injection by overdriven current through a conductor. As happens in single wall nanotubes, carbon nanotubes, semiconductors and metals, electron flow can be so intense that the electrons accelerate enough to cause non-linear or large amplitude phonons. This injects Δk.

All of the methods disclosed and claimed herein can be made and executed without undue experimentation in light of the present disclosure. While the compositions and methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

What is claimed is:

1. A device to create and use transient, modified effective mass electron quasiparticles and ion quasiparticles to stimulate and control reaction rates and reaction branches, comprising
one or more conducting reaction particles;
reactants in or On one or more conducting reaction particles that can be delocalized as ions in the conducting reaction particles;
reactables in one or more conducting reaction particles;
the reactants and reactables chosen such that at least two frona the set including reactants and reactables can form a stable product in an associated state;
one or more conducting reaction particles having an identified and chosen inflection point on its band structure diagram, having an energy at the inflection point above the Fermi level, and having a crystal momentum at the inflection point;
a delocalizing pump to inject energy to &localize reactants in one or more conducting reaction particles;
a crystal momentum pump to inject crystal momentum into one or more conducting reaction particles, the injected momentum being therefore a transient having a transient crystal momentum lifetime;
an electron energy pump to inject energy into a conduction electron of one or more conducting reaction particles, the injected electron energy being therefore a transient having a transient electron energy lifetime;
the electron energy pump configured to inject at least the energy of the inflection point;
the crystal momentum pump configured to inject at least the crystal momentum of the inflection point;
a sink to absorb heat, forms of disorder and exhaust materials;
wherein upon injection of crystal momentum and electron energy, a transient istribution of modified effective mass electrons are formed and couple with delocalized reactant ions, interact with reactants and the electron quasiparticle effective mass implied by the chosen inflection point controls the reaction rate and reaction branch.

2. A device to create and use transient, modified effective mass electron quasiparticles and ion quasiparticles to stimulate and control reaction rates and reaction branches, comprising:
one or more conducting reaction particles;
reactants in or on one or more conducting reaction particles that can he delocalized as ions in the conducting reaction particles;
reactables in the conducting reaction particles;
the reactants and reactables chosen such that at least two from the set including reactants and reactables can form a stable product in an associated state;
one or more conducting reaction particles having an identified and chosen inflection point on its band structure diagram and having an energy at the inflection point above the Fermi level and having a crystal momentum at the inflection point;
a delocalizing pump to inject energy to delocalize reactants;
a crystal momentum pump to inject crystal momentum into one or more conducting reaction particles, the injected momentum being therefore a transient having a transient crystal momentum lifetime;
an electron energy pump to inject energy into a conduction electron of one or more conducting reaction particles, the injected electron energy being therefore a transient having a transient electron energy lifetime;
the electron energy pump configured to inject at least an energy of the inflection point;
the crystal momentum pump configured to inject at least the crystal momentum of the inflection point;
wherein upon injection of crystal momentum and electron energy, a transient distribution of modified effective mass electrons are formed and couple with delocalized reactant ions, interact with reactants and the electron quasiparticle effective mass implied by the chosen inflection point controls the reaction rate and reaction branch.

3. A claim as in claim 2 wherein the crystal momentum pump includes a nanomechanical oscillator energized by electric potential; and
the electron energy pump includes a photon source energized by electrical potential.

4. A device to create, sense and use transient, modified effective mass electron quasiparticles and ion quasiparticles to stimulate and control reaction rates and reaction branches, comprising
one or more conducting reaction particles;
reactants in or on one or more conducting reaction particles that can be delocalized as ions in the conducting reaction particles;
reartables in the conducting reaction particles;
a tailored crystal momentum injection material;
the reactants and reactables chosen such that at least two from the set including reactants and reactables can form a stable product in an associated state;
each of the one or more conducting reaction particles having a minimum dimension across the particle;
the distribution of the minimum dimension across the particle of the one or more conducting reaction particles including at least particles having the dimension across the particle less than 15 nanometers;
one or more conducting reaction particles having an identified and chosen inflection point on its band structure diagram, having an energy at the inflection point above the Fermi level, and having a crystal momentum at the inflection point;
a delocalizing pump to inject energy to delocalize reactants;
a crystal momentum pump to inject crystal momentum into one or more conducting reaction particles, the injected momentum being therefore a transient having a transient crystal momentum lifetime;
an electron energy pump to inject energy into a conduction electron of one or more conducting reaction particles, the injected electron energy being therefore a transient having a transient electron energy lifetime;
the electron energy pump configured to inject at least the energy of the inflection point;
the crystal momentum pump configured to inject at least the crystal momentum of the inflection point;
an energy sensor configured to detect and/or measure at least the products of energetic electron emissions;
a heat sink thermally connected to the energy sensor;
wherein upon injection of crystal momentum and electron energy, a transient distribution of modihed effective mass electrons are formed and couple with delocalized reactant ions, interact with reactants and reactables, the electron quasiparticle effective mass implied by the chosen inflection point controls the reaction rate and reaction branch, and the energy sensor provides data related to reactions.

5. A claim as in claim 4 wherein:
a pump system includes the delocalizing pump, the crystal momentum pump and the electron energy pump;
the pump system comprises an electric energy source configured to pass an electric current through the reaction participants;
the reactant includes deuterium;
a reactable includes deuterium;
the conducting reaction particle includes palladium;
a tailored crystal momentum injection material includes deuterium;
an energy sensor including a thermionic diode with one electrode electrically connected to at least one reaction particle and the other electrode disconnected electrically and physically from the reaction particles,
the energy sensor configured to accumulate electrons emitted from the conducting reaction particles;
wherein accumulated electrons are thereby collected as as useful potential across the electrodes of the thermionic diode.

6. A claim as in claim 5 wherein.
a reactable includes the boron-10 isotope in concentration greater than 0.7 by weight.

7. A claim as in claim 5 wherein
a pump system includes the delocalizing pump, the crystal momentum pump and the electron energy pump;
the sensor configured to provide feedback data to control the energizing of the pump system.

8. A claim as in claim 5 wherein
a pump system includes the delocalizing pump, the crystal momentum pump and the electron energy pump;
reaction participants include one or more reaction particles, reactants, reactables and tailored crystal momentum injection material;
the pump system further comprises a pulsed laser configured to energize reaction participants;
the laser configured with a pulse power per unit area greater than a desorption energy of a tailored momentum injection material with a reaction particle; and
the energy sensor is a thermionic diode.

9. A claim as in claim 8 where
a reactable includes the boron-10 isotope in concentration greater than 0.7% by weight

10. A claim as in claim 5 wherein
a reactable further includes one or more from the group including the isotopes boron-10, the lithium-7, carbon-12, oxygen-17, nitrogen-14, calcium-44, titanium-48, titanium-49.

11. A claim as in claim 4 wherein:
a pump system includes the delocalizing pump, the crystal momentum pump and the electron energy pump;
the pump system comprises an electric energy source configured to pass an electric current through the reaction participants;
the reactant includes deuterium;
the conducting reaction particle palladium;
the tailored crystal momentum injection material includes deuterium;
the energy sensor is a semiconductor junction diode connected to the heat sink; and is configured to accumulate hot electrons emitted or generated from the conducting reaction particles;
wherein accumulated hot electrons are thereby collected as a useful potential across the junction of the diode.

12. A claim as in claim 11 wherein
reaction participants include one or more reaction particles, reactants, reactables and tailored crystal momentum injection material;
the reaction participants are affixed on a substrate;
the substrate is a ceramic semiconductor;
the semiconductor is formed as a pn junction;
the p region of the junction having a degeneratively doped region in contact with at least one reaction particle;
wherein the p region and n region thereby form a semiconductor junction diode.

13. A claim as in claim 11 were
reaction participants include one or more reaction particles, reactants, reactables and tailored crystal momentum injection material;
the reaction participants are affixed on a conducting substrate;
the conducting substrate is affixed on an n-type semiconductor and chosen from materials that form a Schottky junction diode;
the semiconductor configured with one electrode electrically connected to the conducting substrate and the other electrode to the n-type semiconductor,
wherein energized electrons entering the diode charge the diode with a useful potential.

14. A claim as in claim 11 where
a pump system includes the &localizing pump, the crystal entum pump and the electron energy pump;
the sensor provides feedback data to control the pump system.

15. A claim as in claim 4 wherein:
a pump system includes the delocalizing pump, the crystal momentum pump and the electron energy pump;
the pump system comprises an electric energy source configured to pass an electric current through the reaction participants;
the reactant includes deuterium;
the conducting reaction particle includes palladium;
a tailored crystal momentum injection material including deuterium;
the energy sensor configured to measure the energy of a mass energized by emissions from at least one reaction participant.

16. A claim as in claim 15 where
the reaction particles are spread out on a substrate in a manner to approximate a monolayer;
the mass energized by emissions includes a propellant mass placed in a region accessible to energetic particles emitted by a reaction particle,
thereby the propellant masses are energized.

17. A claim as in claim 16 where
reaction participants include one or more reaction particles, reactants, reactables and tailored crystal momentum injection material;
the reaction participants constrained to form layers thinner than the mean free path of electrons emitted by the reaction participants;
the propellant mass includes a gas; and
the energy sensor is configured to measure momentum of the mass energized by emissions.

18. A claim as in claim 16 where
the mass includes a propellant mass placed in a region accessible to energetic particles emitted by a reaction particle;
the energy sensor is configured to measure momentum of the propellant mass.

19. A claim as in claim 15 where
reactable further includes one or more from the group including the isotopes boron-10, the lithium-7, carbon-12, oxygen-17, nitrogen-14, calcium-44, titanium-48, titanium-49.

20. A claim as in claim 4 further including
a sensor configured as a thermionic diode;
a reactant including deuterium;
a conducting reaction particle including palladium;
a proton electrolyte configured to inject a reactant including deuterium into a conducting reaction particle including palladium.

21. A claim as in claim 20 where
a pulsed electrical energy source energizes the proton electrolyte.

22. A claim as in claim 21 wherein
a reactable further includes one or more from the group including the isotopes boron-10, the lithium-7,carbon-12, oxygen-17, nitrogen-14, calcium-44, titanium-48, titanium-49.

23. A claim as in claim 21 further including
a tailored crystal momentum injection material including D₂O.

24. A claim as in claim 21 further including
a tailored crystal momentum injection material including D₂O.

25. A claim as in claim 20 further including
a reactable further includes one or more from the group including the isotopes boron-10, the lithium-7, carbon-12, oxygen-17, nitrogen-14, calcium-44, titanium-48, titanium-49.

26. A claim as in claim 20 further including
a tailored crystal momentum injection material including D₂O.

27. A claim as in claim 20 further including
a tailored crystal momentum Injection material including D₂S.
